(19) United States
(12) Patent Application Publication
(10) Pub. No.: US 2004/0130652 A1
(43) Pub. Date: Jul. 8, 2004

(54) Auto focus system

(76) Inventors: Tadashi Sasaki, Saitama-shi (JP); Atsushi Kanayama, Saitama-shi (JP); Satoshi Yahagi, Saitama-shi (JP)

Correspondence Address: HARNESS, DICKEY & PIERCE, P.L.C., P.O. BOX 8910, RESTON, VA, 20195, US

(21) Appl. No.: 10/741,437

(22) Filed: Dec. 22, 2003

(30) Foreign Application Priority Data
Dec. 27, 2002 (JP) 2002-379164
Dec. 27, 2002 (JP) 2002-379166
Feb. 24, 2003 (JP) 2003-045692

(51) Int. Cl. H04N 5/232

(52) U.S. Cl. 348/349

(57) ABSTRACT

The auto focus system obtains focus information on a lens-interchangeable camera body of a TV camera and sends the focus information to a lens apparatus mounted on the camera body. The lens apparatus controls an auto focus based on the focus information. It is thereby possible to control the focus on adequate conditions according to optical specifications of the lens apparatus and so on.

### BACKGROUND OF THE INVENTION

1. Field of the Invention

The present invention relates to an auto focus system and a filter cut-off frequency change circuit, and in particular, to the auto focus system in a lens-interchangeable camera or the auto focus system of an optical length difference method having a plurality of focus state determination image pickup elements for picking up images of object light incident on a taking lens at positions of different optical lengths and a filter cut-off frequency change circuit applied to an auto focus of a contrast method.

2. Description of the Related Art

An auto focus (AF) of a contrast method is adopted for a broadcast TV camera. In the AF of the contrast method, a signal of a high-frequency component is extracted from a picture signal obtained by the camera, and a focus evaluation value for evaluating whether a contrast is high or low is acquired based on the extracted signal. The focus is controlled by a method called a hill climbing method so that the focus evaluation value becomes peak (maximum).

As for a lens-interchangeable camera, focus drive control by the AF is generally exerted on a camera side rather than a lens side (refer to Japanese Patent Application Publication No. 59-149328 for instance).

Proposals were made in the past as to an auto focus system of an optical length difference method applied to the TV camera and so on (refer to WO 02/099495 A1, WO 02/099496 A1, WO 02/099497 A1 and WO 02/099498 A1 for instance). For instance, the auto focus system of the optical length difference method has a semitransparent mirror placed in a taking lens, and object light incident on the taking lens is branched by the semitransparent mirror into an optical path to image pickup elements of a camera body and a focus state determination optical path. The object light branched into the focus state determination optical path has its images picked up by two image pickup elements (hereafter, focus state determination image pickup elements) placed at positions of different optical lengths, for instance. The picture signals obtained by the focus state determination image pickup elements are added up per range of a screen after having the high-frequency components extracted so as to generate the focus evaluation value indicating a degree of sharpness of an image (contrast).

Here, for instance, the focus state determination image pickup elements are in a positional relationship in which focusing is determinedly performed when the focus evaluation values obtained from the image pickup elements are matching. When the focus evaluation values obtained from the focus state determination image pickup elements are matching, it is determined to be a just focus state, and when they are not matching, it is possible to determine whether it is a front focus or a rear focus depending on which focus evaluation value is large. To be more specific, it is possible to know a current focus state (front focus, rear focus or just focus) based on the focus evaluation values obtained from the focus state determination image pickup elements so as to immediately determine a moving direction of the focus for the sake of focusing or determine that the just focus is performed.

Thus, the focus of the taking lens is controlled and set in a just focus state by such determination, based on the focus evaluation values obtained from the focus state determination image pickup elements.

The above-mentioned auto focus system of the optical length difference method has the following advantages. For instance, the general auto focus system of the contrast method in the past acquires the focus evaluation value by using the picture signals obtained from the image pickup element of the camera body and moves the focus in a direction for increasing the focus evaluation value so that the focus evaluation value becomes a peak point (so-called hill climbing method). In this case, it requires an operation called wobbling for moving the focus back and forth in order to determine an increasing direction of the focus evaluation value. It is also necessary, when moving the focus in the direction for increasing the focus evaluation value, to move the focus beyond the peak point in order to detect the peak point. There are the cases where the focus movement becomes unnatural for that reason. As opposed to this, the auto focus system of the optical length difference method can immediately determine whether or not just-focus and the focusing direction in the case of not just-focus based on the focus evaluation values simultaneously obtained from the focus state determination image pickup elements, so that the above-mentioned operation is not necessary and the focus movement is quite natural.

It is more advantageous, in view of miniaturization and power saving of a system, to provide a device which obtains focus information such as a focus evaluation value for recognizing a focus state on a camera side rather than a lens side so as to have more portions in which picture signal processing of the camera is divertible.

However, it is different according to optical specifications of the lenses and so on as to how to control a focus based on the focus information. It is also difficult to have all the information on interchangeable lenses on the camera side, so that a new lens cannot cope with it as a matter of course. Therefore, it is not desirable to determine to the extent of how to drive the focus based on the focus information on the camera side and provide an instruction therefor from the camera side to the lens side. The focus information necessary for AF is different depending on the optical specifications, shooting conditions such as a focal length and an f-number and an operating state and so on of the lens. Therefore, it is necessary to obtain the focus information on adequate conditions in consideration of the optical specifications of the interchangeable lenses and so on.

In the case of shooting an object including a lot of high-frequency components, a curve representing a focus evaluation value characteristic, that is, the curve on a graph indicating a relationship between a focus position and the focus evaluation value shows a precipitous hill shape of ascent and descent around a peak point of the focus evaluation value. For this reason, there are problems that, even though focus movement control for moving it to a just-focus position and stopping it there is adequate at an average focus evaluation value characteristic, it is too fast at the focus evaluation value characteristic including a lot of high-frequency components, so that the focus exceeds the just-focus position and causes an overshoot or the focus cannot stop at the just-focus position and caused hunting in the auto focus system of the optical length difference method.

In the case of constituting an high-pass filter (HPF) (or a low-pass filter (BPF)) with a digital filter in order to extract the high-frequency (or low-frequency) component from a picture signal, the circuit size becomes larger because, the lower cut-off frequency (fc) becomes, the more necessary it is to increase a degree (tap number) for the sake of obtaining the same characteristic. If the HPF is constituted with custom ICs such as an FPGA and a PLD, the HPF of a low frequency in particular requires many gates and a chip size becomes larger so that cost reduction and miniaturization become difficult.

Therefore, it is not desirable to change a coefficient of the digital filter or use a plurality of HPFs in order to render cut-off frequencies of the HPFs changeable.

### SUMMARY OF THE INVENTION

The present invention has been implemented in consideration of such circumstances, and an object thereof is to provide the auto focus system capable of controlling the focus on the adequate conditions according to the optical specifications, shooting conditions and so on of the lens. Another object of the present invention is to provide the auto focus system of the optical length difference method capable of securely focusing with stable focus movement without having unnatural focus movement depending on the object. A further object of the present invention is to provide the filter cut-off frequency change circuit and the auto focus system capable of changing the frequency components to be interrupted by the filter against the frequency components of subject signals without changing the cut-off frequency by changing the frequency characteristic of the filter itself and without using a plurality of filters.

In order to attain the above-described objects, the present invention is directed to an auto focus system, comprising: a camera body; and a lens apparatus which is detachably mounted on the camera body, wherein the camera body comprises: a focus information obtaining device which obtains focus information based on a picture signal obtained by picking up an image with an image pickup device; and a sending device which sends the focus information obtained by the focus information obtaining device to a focus control device of the lens apparatus, wherein the lens apparatus comprises: an optical system for focusing object light; and the focus control device which comprises: a receiving device which receives the focus information sent by the sending device of the camera body; and an auto focus control device which electrically controls focus of the optical system based on the focus information received by the receiving device so as to automatically perform focusing.

According to the present invention, the focus information necessary for the auto focus is sent from the camera body to the lens apparatus side (focus control device) and the auto focus control based on the focus information is exerted on the lens apparatus side so as to control the focus on the adequate conditions for the optical specifications of the lens apparatus and so on.

Preferably, in the camera body, light to be incident on a video image pickup element is divided into rays for focus state determination, and images of the rays for focus state determination are picked up on a plurality of imaging surfaces placed with optical length differences, and the focus information is obtained based on the picture signals obtained by picking up the images on the imaging surfaces.

Preferably, the focus information is a focus evaluation value generated based on signals of necessary frequency components extracted from the picture signals obtained by picking up the images on the plurality of imaging surfaces.

Preferably, the focus control device demands from the camera body the frequency components necessary for the focus information unique to the lens apparatus. To be more specific, the frequency components of the signals extracted from the picture signals for the sake of generating the focus evaluation value are specified from the lens apparatus side so as to obtain the focus information on the adequate conditions according to the optical specifications of the lens apparatus and so on.

Preferably, the focus control device sends to the camera body a focus range on a screen specified as a range to be focused on by a focus range specification device attached to the lens apparatus.

The present invention is also directed to an auto focus system, comprising: an object light branching device which branches an object light incident on a taking lens from an optical path for obtaining an object image to a focus state determination optical path; a plurality of image pickup devices which pick up images of the object light led to the focus state determination optical path by the object light branching device at positions of different optical lengths; a focus evaluation value generation device which generates a focus evaluation value indicating a degree of sharpness of the image picked up by each of the image pickup devices; a focus control device which controls a focus of the taking lens based on the focus evaluation value generated by the focus evaluation value generation device in correspondence with each of the image pickup devices so as to adjust focus of the taking lens; and an aperture which is placed on the focus state determination optical path so that focal depth of the object light led to the focus state determination optical path is adjusted by adjusting an opening amount of the aperture.

According to the present invention, the aperture is placed in the focus state determination optical path and the focal depth of the object light led to the focus state determination optical path can thereby be adjusted so that it is possible to change the characteristic around the peak of the focus evaluation value. Therefore, it is possible to adjust the object including a lot of high-frequency components so that the characteristic around the peak of the focus evaluation value will not be precipitous so as to allow focusing securely with natural and stable movement without problems such as the overshooting and hunting.

The present invention is also directed to a filter cut-off frequency change circuit, comprising: a filter which, of frequency components of an inputted signal, interrupts one of a frequency component over a predetermined cut-off frequency and a frequency component below the predetermined cut-off frequency; and a transmission speed change circuit which changes a transmission speed of the inputted signal and outputting the signal to the filter, wherein the transmission speed is changed in the transmission speed change circuit so as to change the frequency component interrupted by the filter against the frequency component of the signal inputted to the transmission speed change circuit.

Preferably, the transmission speed change circuit comprises: a storage circuit which temporarily stores the inputted signal; and a read speed control circuit which changes a speed of reading from the storage circuit in order to output the signal stored in the storage circuit to the filter.

The present invention is also directed to an auto focus system, comprising: a high-pass filter which interrupts a frequency component below a predetermined cut-off frequency to extract a high-frequency component from a picture signal obtained by photoelectrically transferring an image formed by an optical system; and a transmission speed change circuit which changes a transmission speed of inputted picture signal and outputs the picture signal to the high-pass filter, wherein the transmission speed is changed in the transmission speed change circuit so as to change the frequency component interrupted by the high-pass filter against the frequency component of the picture signal inputted to the transmission speed change circuit, wherein the auto focus system automatically performs focusing of the optical system based on the high-frequency component extracted by the high-pass filter.

Preferably, the transmission speed change circuit comprises: a storage circuit which temporarily stores the inputted picture signal; and a read speed control circuit which changes a speed of reading from the storage circuit in order to output the picture signal stored in the storage circuit to the high-pass filter.

According to the present invention, the same effect as changing the cut-off frequency of the filter is obtained by changing the speed of transmitting to the filter the signal to be inputted to the filter without changing the frequency characteristic of the filter. Thus, it is not necessary to change the frequency characteristic of the filter or use a plurality of filters of different frequency characteristics (cut-off frequencies) even in the case of changing the frequency components to be interrupted (frequency components to be transmitted) against the frequency components of the subject signal. Therefore, it allows the cost reduction and miniaturization of circuit size of the filter and its peripheral circuits.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a diagram showing a configuration of an optical system in a camera body of a TV camera;

FIG. 2 is a diagram representing a video image pickup element and a pair of focus state determination image pickup elements on the same optical axis respectively;

FIG. 3 is a block diagram showing the configuration of a system mainly related to an auto focus in the camera body and a lens apparatus;

FIG. 4 is an explanatory diagram used to describe a principle of focus state determination;

FIG. 5 is a flowchart showing a procedure of a CPU of the camera body;

FIG. 6 is a flowchart showing the procedure of the CPU of the lens apparatus;

FIG. 7 is a flowchart showing the procedure of the CPU of the lens apparatus;

FIG. 8 is a block diagram of a TV camera system to which an auto focus system according to an embodiment of the present invention is applied;

FIG. 9 is a diagram showing on the same line an optical axis of object light incident on the video image pickup element and the optical axis of the object light incident on a pair of the focus state determination image pickup elements;

FIG. 10 is a block diagram showing the configuration of a control system of the lens apparatus related to focus control;

FIG. 11 is a block diagram showing the configuration of a focus evaluation value generating portion;

FIG. 12 is a diagram showing an appearance of the focus evaluation value against a focus position on shooting a certain object by taking the focus position of a taking lens as a horizontal axis and the focus evaluation value as a vertical axis;

FIG. 13 is a diagram showing a focus evaluation value characteristic in the case where contrast is very high;

FIG. 14 is a block diagram showing the configuration of the control system of the lens apparatus related to aperture control and electronic shutter control. It is a diagram showing the focus evaluation value characteristic in the case where the contrast is very high;

FIG. 15 is a flowchart showing the procedure relating to AF-side aperture control and the electronic shutter control;

FIG. 16 is a flowchart showing the procedure of another embodiment relating to the AF-side aperture control and the electronic shutter control;

FIG. 17 is a block diagram showing an overall configuration of the auto focus system to which an embodiment of the present invention is applied;

FIG. 18 is a diagram showing an example of a relationship between the focus position and the focus evaluation value; and

FIG. 19 is a block diagram showing the configuration of the focus evaluation value generating portion and its peripheral circuits.

### DETAILED DESCRIPTION OF THE PREFERRED EMBODIMENTS

Hereafter, preferable embodiments of an auto focus system according to the present invention will be described in detail by referring to the attached drawings.

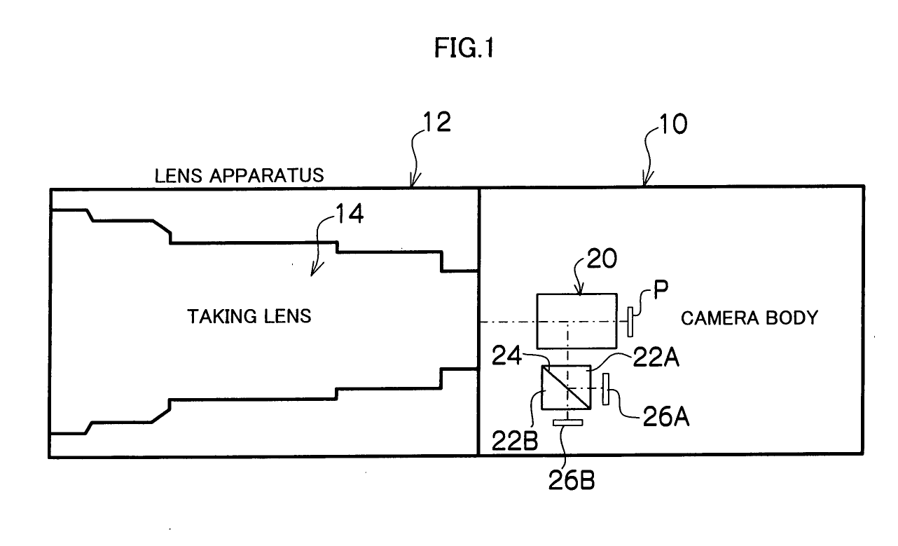

A TV camera shown in FIG. 1 is comprised of a lens-interchangeable camera body 10 and a lens apparatus 12 to be mounted on the camera body 10. The lens apparatus 12 includes a taking lens 14 (optical system) comprised of various fixed and moving lens groups and optical components such as an iris, and a controller (control system) (not shown) for electrically controlling the moving lens (group) and the iris of the taking lens 14.

The camera body 10 has a color separation optical system 20 of which detailed configuration is omitted placed therein, and object light having passed the taking lens 14 is decomposed by the color separation optical system 20 into rays of respective wavebands of red (R), green (G) and blue (B). Each of the light decomposed by the color separation optical system 20 into the colors gets incident on a video image pickup element (two-dimensional CCD) corresponding to each color and is photoelectrically transferred by each video image pickup element. Picture signals for broadcasting are generated by a signal processing circuit not shown. The video image pickup elements are comprised of three image pickup elements for R, G and B, and they are at positions of an equal distance as optical lengths of the object light and are indicated as one video image pickup element P in FIG. 1.

The color separation optical system 20 has a device (not shown) which branches the object light for focus state determination from the incident object light provided thereto. For instance, the object light before being decomposed into the colors of R, G and B is branched from video object light as the object light for focus state determination. For instance, the object light for focus state determination gets incident on a semitransparent mirror surface 24 comprised of two prisms 22a and 22B to be divided equally into reflected light and transmitted light. The reflected light gets incident on an imaging surface of an image pickup element 26A for focus state determination, and the transmitted light gets incident on the imaging surface of an image pickup element 26B for focus state determination. The object light incident on the image pickup elements 26A and 26B are photoelectrically transferred so as to be outputted as the picture signals from the image pickup elements 26A and 26B respectively. Both the image pickup elements 26A and 26B are intended to capture black-and-white images, and the picture signals generated by the image pickup elements 26A and 26B are luminance signals.

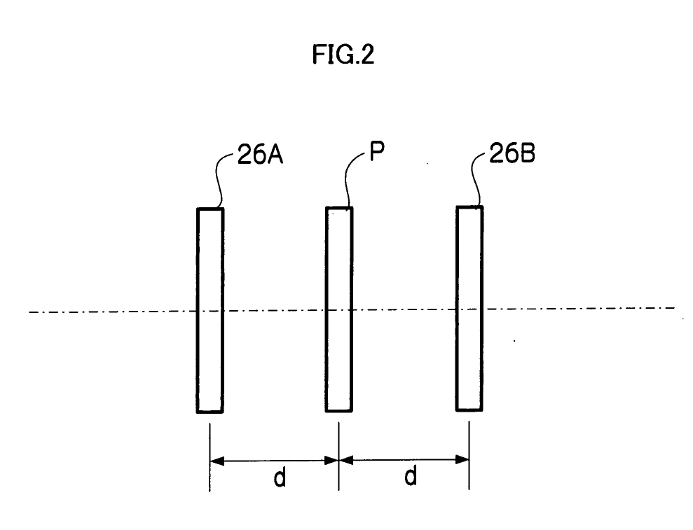

Here, FIG. 2 is a diagram representing the video image pickup element P and the pair of focus state determination image pickup elements 26A and 26B on the same optical axis respectively. As shown in FIG. 2, the optical length of the object light incident on the imaging surface of the focus state determination image pickup element 26A is shorter than the optical length of the object light incident on the imaging surface of the other focus state determination image pickup element 26B, and the optical length of the object light incident on the imaging surface of the video image pickup element P is set to be intermediate length thereof. To be more specific, the imaging surfaces of the pair of the focus state determination image pickup elements 26A and 26B are placed at the positions of the equal distance back and forth to the imaging surface of the video image pickup element P respectively. Therefore, the object light incident on the taking lens 14 has its images picked up by the pair of focus state determination image pickup elements 26A and 26B at the positions of the equal distance back and forth to the imaging surface of the video image pickup element P.

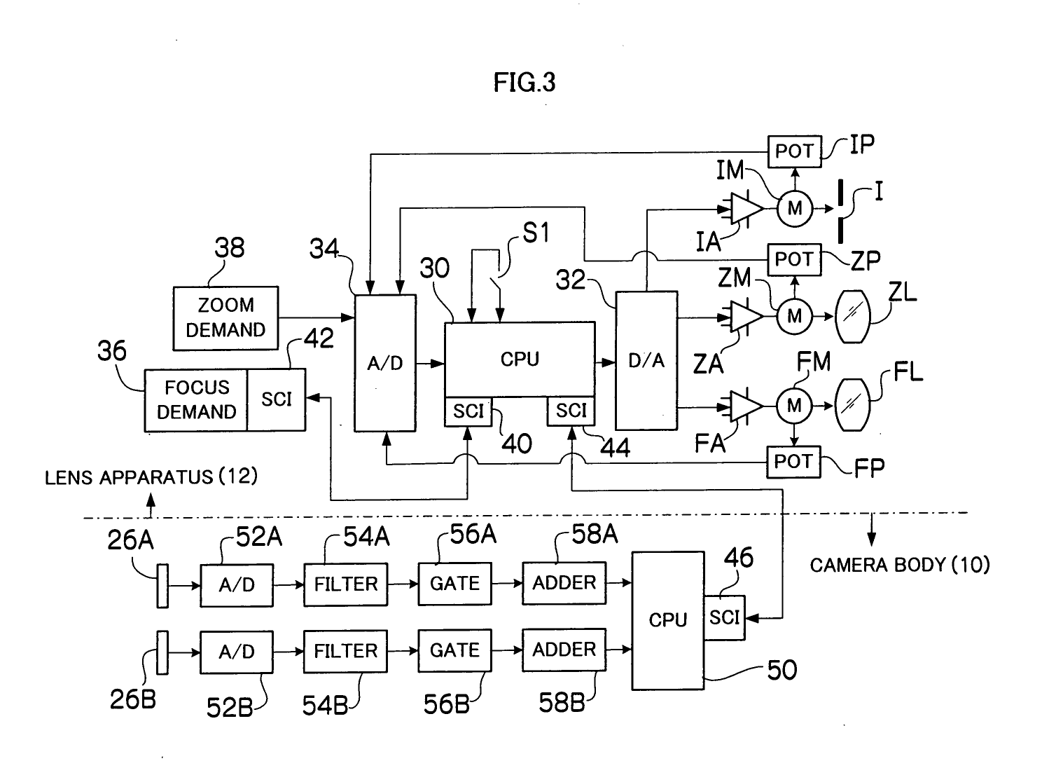

FIG. 3 is a block diagram showing a configuration of a system mainly related to the auto focus in the camera body 10 and lens apparatus 12. In the lens apparatus 12, the taking lens 14 has a focus lens (group) FL to be driven in the optical axis direction for the sake of focusing and a zoom lens (group) ZL to be driven in the optical axis direction for the sake of changing an image magnification (focal length) and so on placed therein as the moving lens group. It also has an iris I to be opened and closed for changing an aperture value placed therein. The focus lens FL, zoom lens ZL and iris I are coupled to a focus motor FM, a zoom motor ZM and an iris motor IM so as to be driven by the motors FM, ZM and IM.

The motors FM, ZM and IM are connected to a focus amplifier FA, a zoom amplifier ZA and an iris amplifier IA. If a driving signal is provided to the amplifiers FA, ZA and IA from a CPU 30 mounted on the lens apparatus 12 via a D/A converter 32, a voltage corresponding to the driving signal is applied to the motors FM, ZM and IM so that the motors FM, ZM and IM are driven at a speed according to the applied voltage.

Therefore, the CPU 30 can control the focus lens FL, zoom lens ZL and iris I at a desired working speed with a voltage value of the driving signal outputted to the amplifiers FA, ZA and IA. Positional information indicating current positions of the focus lens FL, zoom lens ZL and iris I is provided to the CPU 30 from potentiometers FP, ZP and IP via an A/D converter 34. The CPU 30 controls the working speed while referring to their current positions so as to also control the positions of the focus lens FL, zoom lens ZL and iris I.

The lens apparatus 12 can have lens controllers such as a focus demand 36 for manually operating the focus and a zoom demand 38 for manually operating the zoom connected thereto as lens accessories. The focus demand 36 shown in FIG. 3 is a digital lens controller. If the focus demand 36 is connected to the lens apparatus 12, the focus demand 36 and the CPU 30 of the lens apparatus 12 are communication-connected by SCIs (Serial Communication Interfaces) 40 and 42 so as to exchange various signals by serial communication. Thus, for instance, a command signal indicating an objective position of the focus is provided from the focus demand 36 to the CPU 30 based on manual operation of a predetermined focus operation member (a focus ring for instance). In a manual focus mode, the CPU 30 controls the position of the focus lens FL based on the command signal, and sets the focus at the objective position provided by the command signal.

The zoom demand 38 shown in FIG. 3 is an analog lens controller. If the zoom demand 38 is connected to the lens apparatus 12, for instance, the command signal indicating an objective speed of the zoom is provided to the CPU 30 based on the manual operation of a zoom operation member via the A/D converter 34. The CPU 30 controls the working speed of the zoom lens ZL based on the command signal, and moves the zoom at the objective speed provided by the command signal. The lens apparatus 12 has an AF switch S1 for switching between a manual focus mode and an auto focus mode provided thereto. In the case where the AF switch S1 is off, the CPU 30 performs a manual focus process. In the case where the AF switch S1 is turned on, the CPU 30 performs an auto focus process. In the manual focus process, it controls the focus lens FL based on the command signal from the focus demand 36. In the auto focus process, it performs the serial communication with a CPU 50 of the camera body 10 with SCIs 44 and 46 so as to obtain the focus information from the camera body 10 as will be described in details later. It controls the focus lens FL and automatically adjust the focus based on the focus information. A description will be given later as to concrete exchange of the signals between the CPU 30 of the lens apparatus 12 and the CPU 50 of the camera body 10.

The camera body 10 has processing circuits 52A to 58A and 52B to 58B mounted thereon for the sake of generating the focus evaluation value indicating a contrast level of the images picked up by the above-mentioned focus state determination image pickup elements 26A and 26B. These processing circuits are constituted likewise for both the focus state determination image pickup elements 26A and 26B, so that the processing circuits 52A to 58A constituted for the focus state determination image pickup element 26A will be described here.

As shown in the drawing, the picture signals outputted from the focus state determination image pickup element 26A are first converted into digital signals by an A/D converter 52A. Subsequently, only the signals of a predetermined frequency component are extracted from the picture signals by a digital filter 54A so that only the signals in a predetermined focus range to be set up in the shooting range (on the screen) are extracted from the extracted signal of the predetermined frequency component by a gate circuit 56A.

The digital filter 54A has its frequency characteristic changed by a parameter (filter parameter) set by the CPU 50. In principle, it is set at the characteristic for extracting the frequency component capable of determining the contrast of the image. It has an upper cut-off frequency on interrupting high-frequency components of a predetermined frequency or higher and a lower cut-off frequency on interrupting low-frequency components of a predetermined frequency or lower set at appropriate values according to optical specifications, shooting conditions such as a focal length (zoom position) and an f-number and an operating state and so on of the lens apparatus 12. The filter parameter is determined by the CPU 30 of the lens apparatus 12 in consideration of the optical specifications, shooting conditions such as a focal length (zoom position) and an f-number and operating state and so on of the lens apparatus 12 for the sake of extracting necessary frequency components so as to be sent to the CPU 50 of the camera body 10. The focus range in which the signals are extracted by the gate circuit 56A can be changed by processing of the CPU 50. For instance, in the case where the lens accessory such as the focus demand 36 has the device which specifies the focus range (position, size, shape and so on), the information on the focus range specified by that device is sent to the CPU 50 of the camera body 10 via the CPU 30 of the lens apparatus 12 so that the CPU 50 specifies the focus range according to that information.

The signals extracted by the gate circuit 56A are subsequently inputted to an adder 58A, and are added up per image (equivalent to one field portion of the picture signals of an interlace method) by the adder 58A. The signals obtained by summation of the adder 58A are the values indicating a degree of focusing (contrast level) for the object in the focus range, and the values obtained by the adder 58A are sequentially read as the focus evaluation values by the CPU 50. The focus evaluation values thus obtained by the picture signals from the focus state determination image pickup element 26A are referred to as channel (ch) A focus evaluation values, and likewise, the focus evaluation values obtained by the picture signals from the focus state determination image pickup element 26B are referred to as ch B focus evaluation values.

The CPU 50 of the camera body 10 sends the ch A and ch B focus evaluation values thus obtained as the focus information to the CPU 30 of the lens apparatus 12.

Next, an outline of AF processing in the CPU 30 of the lens apparatus 12 will be described. It is possible, as described above, to determine the current focus state of the taking lens 14 against the imaging surface of the video image pickup element P based on the ch A and ch B focus evaluation values thus obtained from the CPU 50 of the camera body 10.

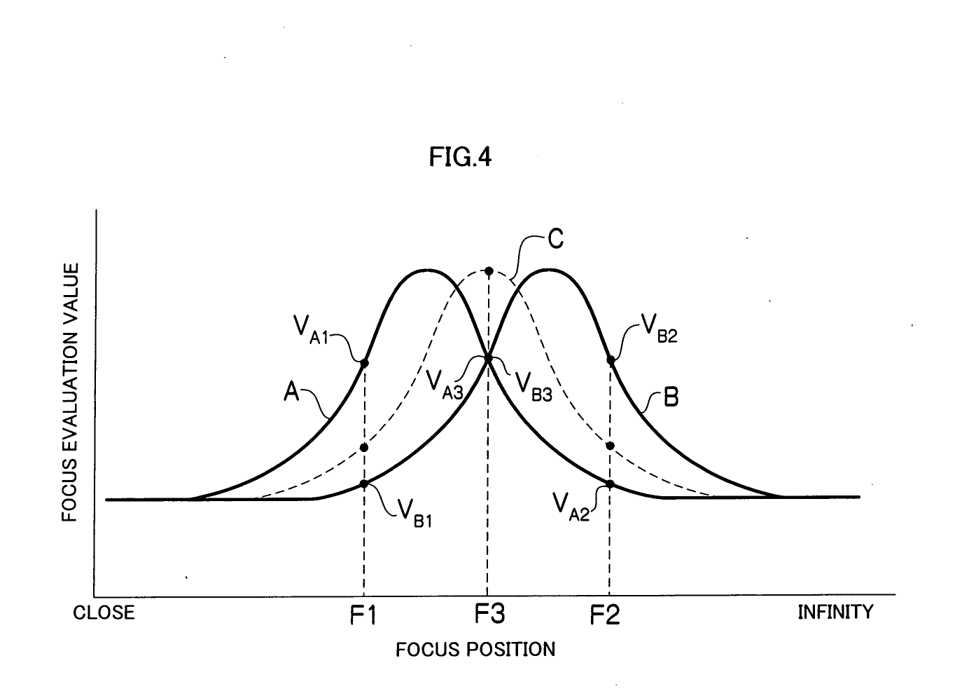

FIG. 4 is a diagram showing an appearance of the focus evaluation values against the focus position on shooting a certain object by taking the position of the focus lens FL (focus position) as a horizontal axis and the focus evaluation value as a vertical axis. A curve C shown by the broken line in FIG. 4 shows the focus evaluation value against the focus position on the assumption that the focus evaluation value is acquired from the picture signal from the video image pickup element (or the image pickup element placed at a position coupled to the video image pickup element). Curves A and B shown in full line in FIG. 4 show the ch A and ch B focus evaluation values obtained from the image pickup elements 26A and 26B for focus state determination against the focus position respectively. In FIG. 4, a position F3 at which the focus evaluation value of the curve C becomes the largest (maximum) is the just-focus position.

In the case where the focus position of the taking lens 14 is set at F1 in FIG. 4, a ch A focus evaluation value V_{A1} becomes the value corresponding to a position F1 of the curve A, and a ch B focus evaluation value V_{B1} becomes the value corresponding to a position F1 of the curve B. In this case, the ch A focus evaluation value V_{A1} becomes larger than the ch B focus evaluation value V_{B1}. For this reason, it can be known that it is in the state in which the focus position is set further on a close side than the just-focus position (F3), that is, the state of a front focus.

In the case where the focus position of the taking lens 14 is set at F2 in FIG. 4, a ch A focus evaluation value V_{A2} becomes the value corresponding to a position F2 of the curve A, and a ch B focus evaluation value V_{B2} becomes the value corresponding to a position F2 of the curve B. In this case, the ch A focus evaluation value V_{A2} becomes smaller than the ch B focus evaluation value V_{B2}. For this reason, it can be known that it is in the state in which the focus position is set further on an infinity side than the just-focus position (F3), that is, the state of a rear focus.

As opposed to this, in the case where the focus position of the taking lens 14 is set at F3, that is, the just-focus position, a ch A focus evaluation value V_{A3} becomes the value corresponding to the position F3 of the curve A, and a ch B focus evaluation value V_{B3} becomes the value corresponding to the position F3 of the curve B. In this case, the ch A focus evaluation value V_{B3} becomes equal to the ch B focus evaluation value V_{B3}. For this reason, it can be known that it is in the state in which the focus position is set at the just-focus position (F3).

Thus, it is possible, based on the ch A and ch B focus evaluation values, to determine which of the front focus, rear focus and just focus the current focus state of the taking lens 14 is.

Accordingly, the CPU 30 of the lens apparatus 12 controls the position of a focus lens 16 based on the ch A and ch B focus evaluation values obtained from the CPU 50 of the camera body 10, and moves the focus lens 16 to the just-focus position. To be more specific, in the case where the ch A and ch B focus evaluation values are determined as the front focus, it moves the focus lens 16 in the infinity direction. In the case where they are determined as the rear focus, it moves the focus lens 16 in the close direction. If determined as the just-focus, it stops the focus lens 16 at that position so as to set the focus lens 16 at the just-focus position. The shapes of the curves A and B in FIG. 4 become different depending on the optical specifications, shooting conditions and so on of the lens, so that there may be a problem that hills of the curves A and B do not intersect. It is possible, on the other hand, to change the shapes of these curves by the characteristics of the digital filters 54A and 54B in FIG. 3, and it is important to set the parameters of the digital filters 54A and 54B at the adequate values in consideration of the optical specifications, shooting conditions and so on of the lens so as not to have the above-mentioned problem. According to this embodiment, the above-mentioned problem occurs less often because the lens apparatus 12 determines the parameter to be the adequate value in consideration of its own optical specifications, shooting conditions and so on.

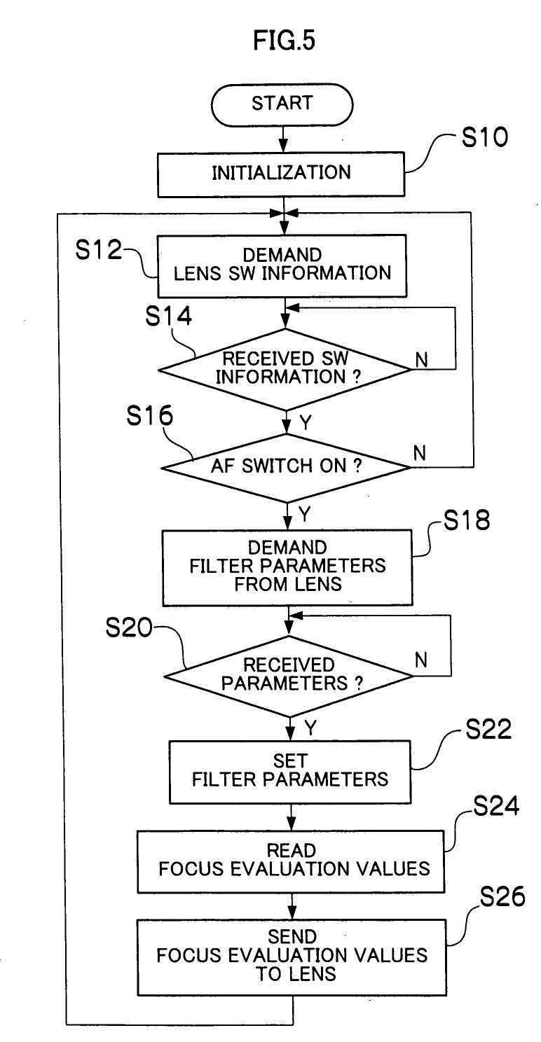

Next, the exchange of the signals between the CPU 30 of the lens apparatus 12 and the CPU 50 of the camera body 10 will be described by using flowcharts in FIGS. 5 to 7. To describe the processing of the CPU 50 of the camera body 10, as shown in FIG. 5, the CPU 50 first performs required initialization (step S10), and then demands switch information from the lens apparatus 12 (step S12). The switch information includes the information indicating an on/off state of the AF switch S1. Next, it determines whether or not it has received the switch information from the lens apparatus 12 (step S14). It repeats the determination at the step S14 while determining as NO. In the case of determining it as YES, it determines whether or not the state of the AF switch S1 obtained from the switch information next is on (step S16). In the case of determining it as NO, it returns to the step S12. In the case of determining it as YES, it demands filter parameters from the lens apparatus 12 (step S18). Here, the filter parameters designate the parameters of the digital filters 54A and 54B in FIG. 3 which set the characteristics of the digital filters 54A and 54B. Next, the CPU 50 determines whether or not it has received the filter parameters from the lens apparatus 12 (step S20). It repeats the step S20 while determining as NO. In the case of determining it as YES, it sets the received filter parameters (step S22), and reads the ch A and ch B focus evaluation values (step S24). It sends the ch A and ch B focus evaluation values read to the lens apparatus 12 (step S26). If the above process is finished, it returns to the step S12.

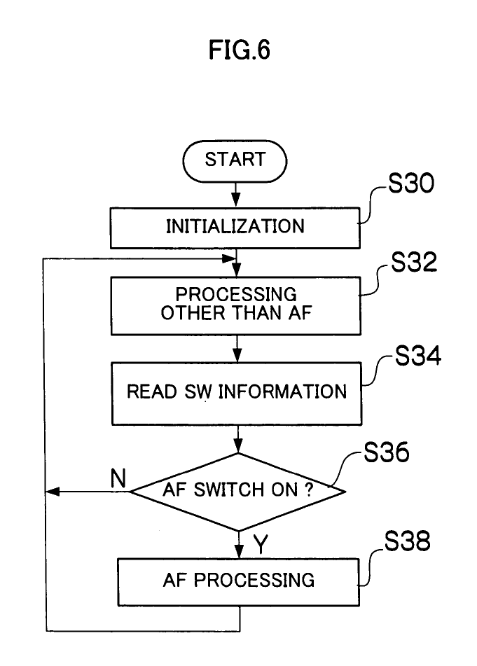

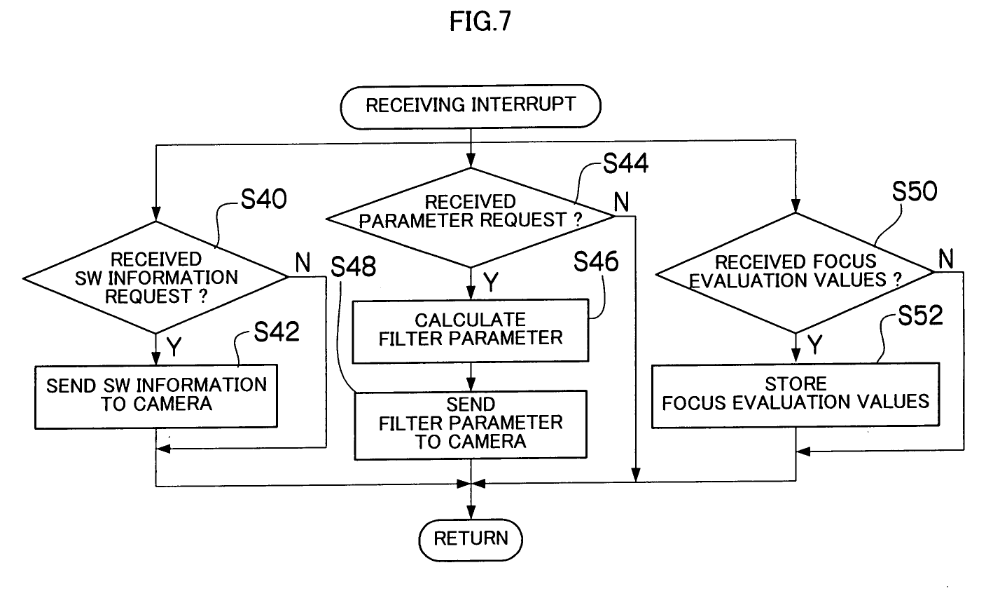

Next, to describe the processing of the CPU 30 of the lens apparatus 12, the CPU 30 first performs the required initialization (step S30), and executes the processing other than AF (step S32) as shown in FIG. 6. It reads the switch information next (step S24). It reads the state of the AF switch S1 as the switch information. It subsequently determines whether or not the AF switch S1 is on (step S26). In the case of determining it as NO, it returns to the step S32. In the case of determining it as YES, it performs the above-mentioned AF process (step S38), and it returns to the step S32. Here, on receiving a request to receive the signal from the camera body 10, the CPU 30 performs an interrupt in FIG. 7. First, it determines whether or not it has received a switch information request corresponding to the step S12 in FIG. 5 from the camera body 10 (step S40). In the case of determining it as YES, it sends the switch information (the state of the AF switch S1 for instance) to the camera body 10 (step S42).

In the case of determining it as NO at the step S40, it determines whether or not it has received a filter parameter request corresponding to the step S18 in FIG. 5 (step S44). In the case of determining it as YES, it calculates the filter parameter (step S46), and sends the filter parameter to the camera body 10 (step S48). The CPU 30 calculates the filter parameter optimum to the auto focus in consideration of the optical specifications, shooting conditions such as a focal length (zoom position) and an f-number and operating state and so on of the lens apparatus 12 so as to send it to the camera body 10.

In the case of determining it as NO at the step S44, it determines whether or not it has received the focus evaluation values corresponding to the step S26 in FIG. 5 (step S50). In the case of determining it as YES, it stores the focus evaluation values (step S52), and uses them in the AF processing at the step S38 in FIG. 6.

Although it is not shown in the flowcharts in FIGS. 5 to 7, in the case of allowing the focus range indicating coverage of the auto focus on the screen to be specifiable by the lens accessory such as the focus demand 36, the following method can be applied. For instance, the signal requesting that information is sent from the CPU 50 of the camera body 10 to the CPU 30 of the lens apparatus 12, and the CPU 30 of the lens apparatus 12 complies with the request and sends the focus range specified by the lens accessory to the CPU 50 of the camera body 10. The CPU 50 of the camera body 10 sets the focus range received from the CPU 30 of the lens apparatus 12 as a signal extraction range of the gate circuits 56A and 56B in FIG. 3.

According to the above embodiment, the camera body 10 sends to the lens apparatus 12 the ch A and ch B focus evaluation values as the focus information obtained by picking up the images of the object light on two imaging surfaces placed at positions of different optical lengths. However, the focus information is not limited thereto. For instance, there may also be the cases where, without providing the focus state determination image pickup elements, the focus evaluation values are generated from the picture signals obtained by the video image pickup elements, and are sent as the focus information to the lens apparatus 12, and the lens apparatus 12 has the focus lens FL set at the just-focus position by the so-called hill climbing method. To be more specific, the present embodiment is characterized in that the camera body 10 does not determine how to drive the focus based on the focus information and send a focus driving signal to the lens apparatus 12 as in the past, but the camera body 10 merely generates the focus information for determining the focus state and sends it to the lens apparatus 12 so that the lens apparatus 12 determines how to drive the focus based on the focus information and executes it.

Next, other embodiments will be described.

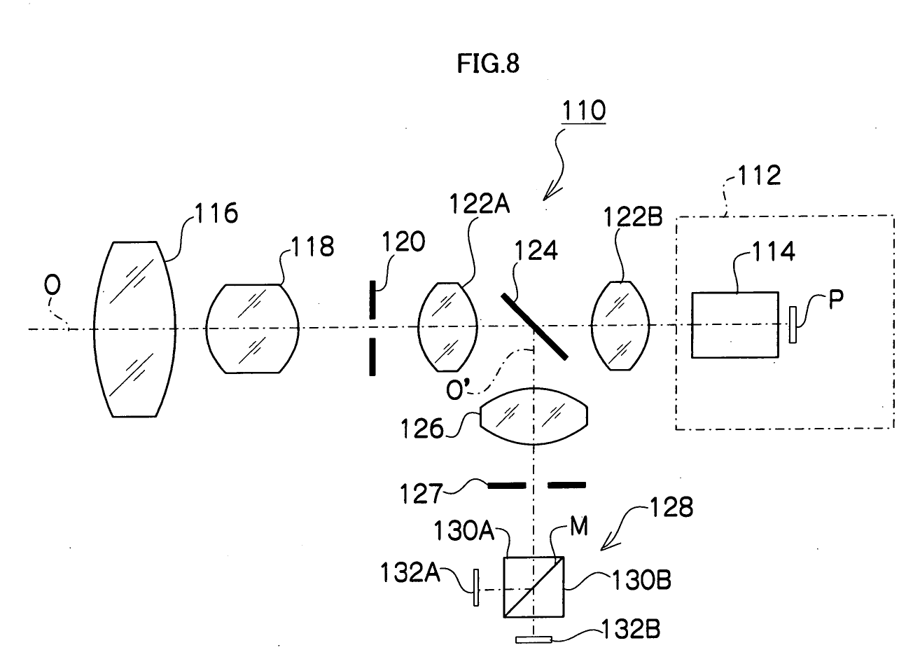

FIG. 8 is a block diagram of a TV camera system to which the auto focus system according to an embodiment of the present invention is applied. As shown in FIG. 8, the TV camera system is comprised of a lens apparatus 110, a camera body 112 and so on. The camera body 112 has the image pickup elements (hereafter, referred to as video image pickup elements) for capturing the images to be televised and outputting the picture signals in a predetermined form or recording them on a recording medium, required circuits and so on mounted thereon.

The lens apparatus 110 is detachably mounted on the camera body 112, and is mainly comprised of the optical system (taking lens) and the control system. First, to describe the configuration of the taking lens, the taking lens has a focus lens (group) 116, a zoom lens (group) 118, an aperture 120, the relay lens (relay optical system) comprised of a front side relay lens 122A and a rear side relay lens 122B placed therein. A semitransparent mirror 124 for branching the object light incident on the taking lens into the focus state determination optical path is placed between the front side relay lens 122A and the rear side relay lens 122B.

The semitransparent mirror 124 is placed being inclined to an optical axis 0 of the taking lens by approximately 45 degrees so that a portion (⅓ amount of light for instance) of the object light having passed the front side relay lens 122A is reflected on the focus state determination optical path at right angles as the object light for focus state determination.

The object light having passed the semitransparent mirror 124 is emitted from the rear end side of the taking lens as the object light for video (for obtaining an object image), and then gets incident on an image pickup portion 114 of the camera body 112. Although the configuration of the image pickup portion 114 will be omitted here, the object light incident on the image pickup portion 114 is decomposed into three colors of a red ray, a green ray and a blue ray by the color separation optical system for instance, and gets incident on the imaging surface of the video image pickup element of each color. Color images to be televised are thereby captured. A focus surface P in the drawing shows a position optically equivalent to the imaging surface of each video image pickup element on the optical axis 0 of the taking lens.

The object light reflected on the semitransparent mirror 124 proceeds along the focus state determination optical path along an optical axis O′ vertical to the optical axis 0 as the object light for focus state determination (for the auto focus (AF)), and gets incident on a relay lens 126. It is focused on the relay lens 126, and gets incident on a focus state determination portion 128 via an aperture 127. The aperture 127 is referred to as an AF aperture 127 in order to distinguish it from the aperture 120.

The focus state determination portion 128 is comprised of two prisms 130A and 130B constituting a light division optical system and a pair of image pickup elements 132A and 132B for focus state determination (hereafter, referred to as focus state determination image pickup elements 132A and 132B).

As described above, the object light reflected on the semitransparent mirror 124 proceeds along the optical axis O′, and gets incident on the first prism 130A first. It is equally divided into the reflected light and transmitted light on a semitransparent mirror surface M of the first prism 130A. The reflected light thereof gets incident on the imaging surface of the focus state determination image pickup element 132A, and the transmitted light gets incident on the other focus state determination image pickup element 132B. For instance, ⅙ amount of light of the entire object light incident on the taking lens gets incident on the imaging surface of each of the focus state determination image pickup elements 132A and 132B.

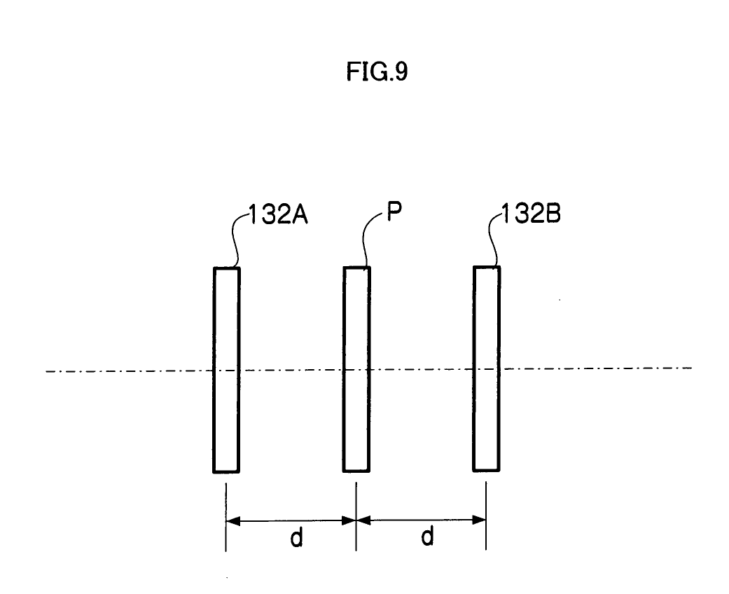

FIG. 9 is a diagram showing on the same line the optical axis of the object light incident on the video image pickup element of the camera body 112 and the optical axis of the object light incident on the pair of the focus state determination image pickup elements 132A and 132B. As shown in FIG. 9, the optical length of the object light incident on the focus state determination image pickup element 132A is set to be shorter than that of the object light incident on the other focus state determination image pickup element 132B, and the optical length of the object light incident on the imaging surface (focus surface P) of the video image pickup element is set to be intermediate length thereof. To be more specific, (the imaging surfaces of) the pair of the focus state determination image pickup elements 132A and 132B are placed at the positions of the equal distance (d) back and forth to the imaging surface (focus surface P) of the video image pickup element respectively.

Therefore, the object light for determining the focus state branched by the semitransparent mirror 124 has its images picked up by the pair of focus state determination image pickup elements 132A and 132B at the position of the equal distance back and forth to the imaging surface (focus surface P) of the video image pickup element. The focus state determination image pickup elements 132A and 132B are intended to obtain the picture signals for determining the focus state (auto focus control) as will be described later, and they do not need to pick up the color images so that they are CCDs for picking up black-and-white images according to this embodiment.

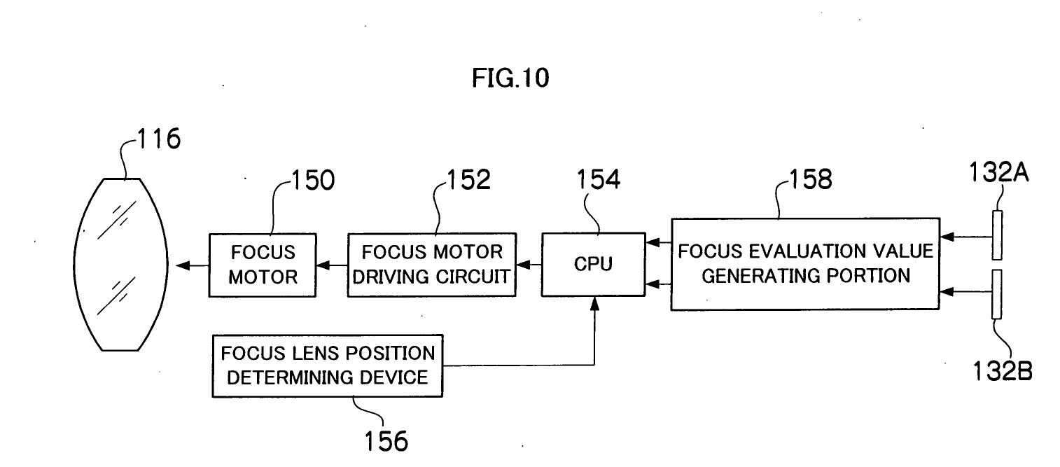

Next, a description will be given as to the control system related to the auto focus control in the lens apparatus 110. FIG. 10 is a block diagram showing the configuration of the control system related to the focus control. The focus lens 116 is coupled to a focus motor 150 as shown in FIG. 10, and if the focus motor 150 is driven, the focus lens 116 moves in the optical axis direction so as to change the focus. The focus motor 150 is given a driving voltage from a focus motor driving circuit 152, and the focus motor driving circuit 152 is given a control signal from a CPU 154.

The control signal from the CPU 154 indicates a voltage value corresponding to a rotational speed of the focus motor 150, that is, a movement speed of the focus lens 116 for instance. If the voltage value is given to the focus motor driving circuit 152, the voltage is thereby amplified so that the amplified voltage is applied as the driving voltage to the focus motor 150. Thus, the rotational speed of the focus motor 150 is controlled by the CPU 154.

The CPU 154 is given a focus position signal of the value corresponding to the current position of the focus lens 116 from a focus lens position determining device 156. Therefore, it is possible, in the process of the CPU 154, to control the working speed of the focus lens 116 to be a desired speed by controlling the rotational speed of the focus motor 150 as described above. It is also possible to control the setting position of the focus lens 116 to be a desired position by controlling the rotational speed of the focus motor 150 while obtaining the focus position signal from the focus lens position determining device 156.

It is also possible to switch the focus control to manual focus control by using a predetermined switch which is not shown. In the case of the manual focus control, the CPU 154 is given the command signal from the focus demand and so on according to the manual operation of an operator, where the position of the focus lens 116 and so on are controlled as described above based on the command signal.

The images (video) picked up by the pair of focus state determination image pickup elements 132A and 132B are outputted as the picture signals for sequentially transmitting pixel values along a plurality of scanning lines (horizontal lines) constituting one screen, and are inputted to a focus evaluation value generating portion 158. Although the configuration and processing of the focus evaluation value generating portion 158 will be described later, the focus evaluation values indicating the contrast (degree of sharpness) levels of the images picked up by the focus state determination image pickup elements 132A and 132B are generated from the picture signals obtained by the image pickup elements 132A and 132B in the focus evaluation value generating portion 158, and the generated focus evaluation values are given to the CPU 154. The focus evaluation values generated based on the picture signals from the focus state determination image pickup element 132A are referred to as the channel A (ch A) focus evaluation values, and the focus evaluation values obtained based on the picture signals from the focus state determination image pickup element 132B are referred to as the channel B (ch B) focus evaluation values.

As will be described in detail later, the CPU 154 obtains the ch A and ch B focus evaluation values from the focus evaluation value generating portion 158, and controls the position of the focus lens 116 based on the obtained focus evaluation values so that the focus state of the taking lens becomes just focus.

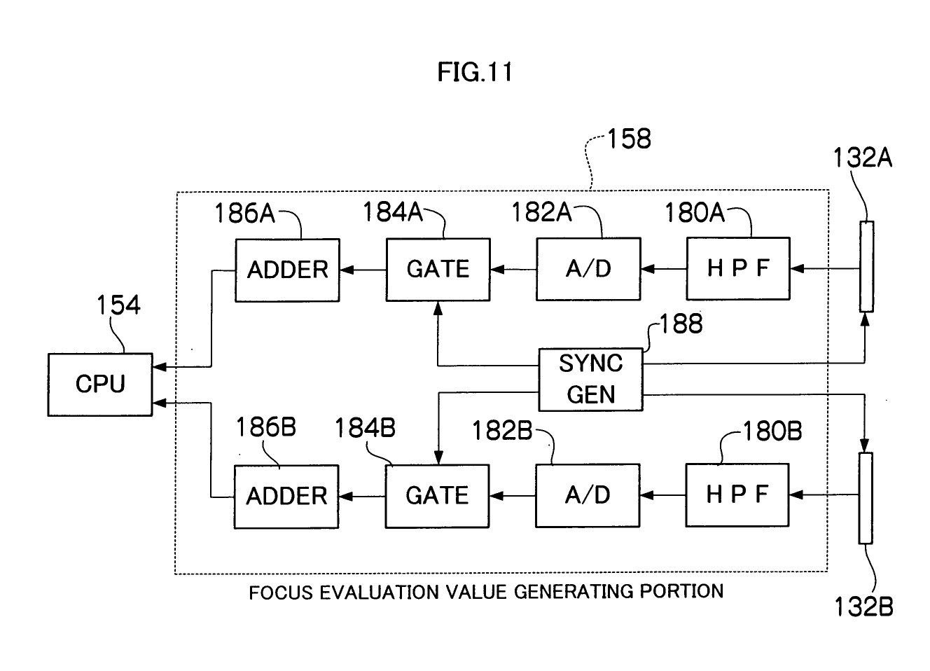

Here, the configuration and processing of the focus evaluation value generating portion 158 will be described. As shown in FIG. 11, the picture signals outputted from the focus state determination image pickup elements 132A and 132B are inputted to A/D converters 180A and 180B of the focus evaluation value generating portion 158 respectively, and are converted into digital signals respectively. Both the focus state determination image pickup elements 132A and 132B are the CCDs for capturing the black-and-white images, and the picture signals outputted from the focus state determination image pickup elements 132A and 132B are luminance signals indicating luminance values of the pixels constituting each screen.

The picture signals converted into the digital signals by the A/D converters 180A and 180B are inputted to high-pass filters (HPF) 182A and 182B respectively, where the signals of the high-frequency components included in the picture signals are extracted. The signals of the high-frequency components extracted by HPFs 182A and 182B respectively are inputted to gate circuits 184A and 184B.

As for the signals of the high-frequency components inputted to the gate circuits 184A and 184B, only the signals in the range corresponding to the pixels in a predetermined focus area on the screen (center of the screen for instance) are extracted therefrom, and they are inputted to adders 186A and 186B respectively. They are added by the adders 186A and 186B. It is thereby possible to acquire a sum of the values of the high-frequency components of the picture signals in the focus area. The values obtained by the adders 186A and 186B are the focus evaluation values indicating the level of the degree of sharpness (contrast) of the images in the focus area. The focus evaluation values obtained by the adder 186A are given to the CPU 154 as the channel A (ch A) focus evaluation values, while the focus evaluation values obtained by the adder 186B are given to the CPU 154 as the channel B (ch B) focus evaluation values.

A synchronization signal generating circuit 188 shown in FIG. 11 provides various synchronization signals to the focus state determination image pickup elements 132A and 132B and the circuits such as the gate circuits 184A and 184B so as to synchronize the processing of the circuits.

Subsequently, to describe determination of the focus state and the focus (focus lens 116) control based on the focus evaluation values, it is possible to determine the current focus state of the taking lens against the imaging surface (focus surface P) of the video image pickup element with the ch A and ch B focus evaluation values obtained from the focus evaluation value generating portion 158 as described above.

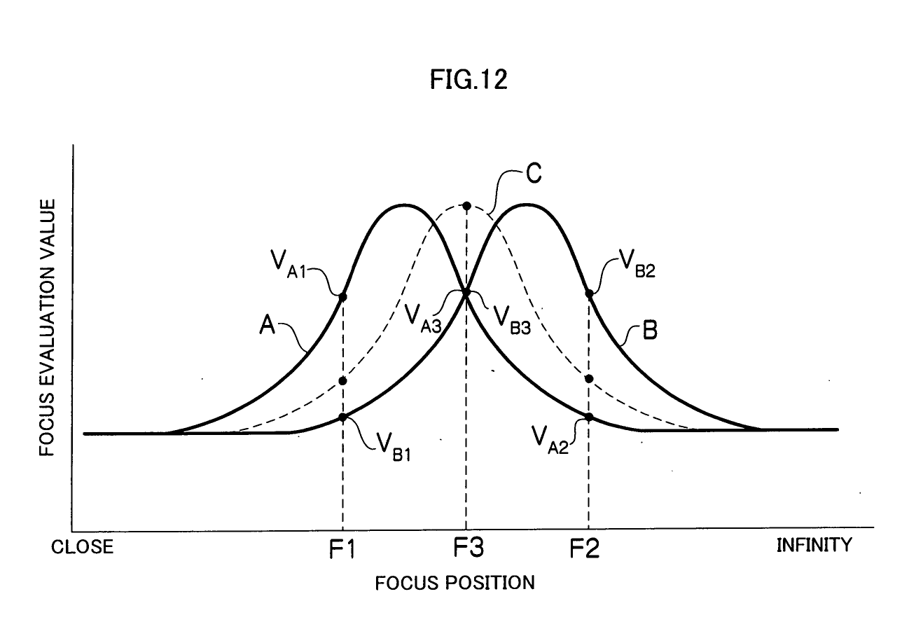

FIG. 12 is a diagram showing a distribution characteristic of the focus evaluation values against the focus position on shooting a certain object by taking the position of the focus lens 116 (focus position) as the horizontal axis and the focus evaluation value as the vertical axis. The curve C shown by the broken line in FIG. 12 shows the focus evaluation value against the focus position on the assumption that the focus evaluation value is acquired from the picture signal from the video image pickup element (or the image pickup element placed at the position coupled to the video image pickup element). The curves A and B shown in full line in FIG. 12 show the ch A and ch B focus evaluation values obtained from the focus state determination image pickup elements 132A and 132B against the focus position respectively. In FIG. 12, the position F3 at which the focus evaluation value of the curve C becomes the largest (maximum) is the just-focus position.

In the case where the focus position of the taking lens is set at F1 in FIG. 12, the ch A focus evaluation value V_{A1} becomes the value corresponding to the position F1 of the curve A, and the ch B focus evaluation value V_{B1} becomes the value corresponding to the position F1 of the curve B. In this case, the ch A focus evaluation value V_{A1} becomes larger than the ch B focus evaluation value V_{B1}. For this reason, it can be known that it is in the state in which the focus position is set further on the close side than the just-focus position (F3), that is, the state of the front focus.

In the case where the focus position of the taking lens is set at F2 in FIG. 12, the ch A focus evaluation value V_{A2} becomes the value corresponding to the position F2 of the curve A, and the ch B focus evaluation value V_{B2} becomes the value corresponding to the position F2 of the curve B. In this case, the ch A focus evaluation value V_{A2} becomes smaller than the ch B focus evaluation value V_{B2}. For this reason, it can be known that it is in the state in which the focus position is set further on the infinity side than the just-focus position (F3), that is, the state of the rear focus.

As opposed to this, in the case where the focus position of the taking lens is set at F3, that is, the just-focus position, the ch A focus evaluation value VA3 becomes the value corresponding to the position F3 of the curve A, and the ch B focus evaluation value VB3 becomes the value corresponding to the position F3 of the curve B. In this case, the ch A focus evaluation value VA3 becomes equal to the ch B focus evaluation value VB3. For this reason, it can be known that it is in the state in which the focus position is set at the just-focus position (F3).

Thus, it is possible, based on the ch A and ch B focus evaluation values obtained from the focus evaluation value generating portion 158, to determine which of the front focus, rear focus and just focus the current focus state of the taking lens is.

Accordingly, it is possible to move the focus lens 116 to the just-focus position by controlling the position of the focus lens 116 based on the ch A and ch B focus evaluation values obtained from the focus evaluation value generating portion 158. To be more specific, in the case where the ch A and ch B focus evaluation values are in the state to be determined as the front focus, it moves the focus lens 116 in the infinity direction. In the case where they are in the state to be determined as the rear focus, it moves the focus lens 116 in the close direction. If in the state to be determined as just-focus, it stops the focus lens 116 at that position so as to move the focus lens 116 to the just-focus position.

Thus, the CPU 154 controls the focus lens 116 as follows based on the ch A and ch B focus evaluation values. First, if the ch A focus evaluation value obtained from the focus evaluation value generating portion 158 is AFV_A and the ch B focus evaluation value is AFV_B, it is the state of the front focus in the case of AFV_A>AFV_B. Therefore, the CPU 154 changes a currently set moving target position of the focus lens 116 to the infinity side just by a travel distance (positive value) described later, and outputs the control signal for moving the focus lens 116 to the new moving target position to the focus motor driving circuit 152. Inversely, in the case of AFV_A<AFV_B, it is the state of the rear focus. Therefore, it changes the currently set moving target position of the focus lens 116 to the close side just by the travel distance (negative value) described later, and outputs the control signal for moving the focus lens 116 to the new moving target position to the focus motor driving circuit 152. It repeats such a process, and in the case where it becomes AFV_A=AFV_B, it stops the movement of the focus lens 116. Thus, the focus lens 116 moves to the just-focus position.

Here, if the value of the focus position signal indicating the current position of the focus lens 116 (focus position data) obtained from the focus lens position determining device 156 is F_POSI, and the moving target position of the focus lens 116 set as described above is AF_CTRL, the CPU 154 outputs the value acquired by subtracting the current position F_POSI from the moving target position AF_CTRL, that is, AF_CTRL-F_POSI as the value of the control signal F_SPEED to the focus motor driving circuit 152. The control signal outputted to the focus motor driving circuit 152 is the value corresponding to the rotational speed of the focus motor 142 (movement speed of the focus lens 116) ordered to the focus motor driving circuit 152. The focus lens 116 moves at the speed corresponding to the difference (AF_CTRL-F_POSI) between the moving target position AF_CTRL and the current position F_POSI by outputting the value of the control signal F_SPEED set as described above to the focus motor driving circuit 152.

Subsequently, a description will be given as to the travel distance to be added to the current moving target position when setting a new moving target position of the focus lens 116. As described above, the difference between the current position F_POSI and the moving target position AF_CTRL of the focus lens 116 is corresponding to the movement speed of the focus lens 116. The larger the travel distance to be added to the current moving target position when setting a new moving target position AF_CTRL is, the faster the movement speed of the focus lens 116 becomes. The smaller the travel distance is, the slower the movement speed of the focus lens 116 becomes.

To stop the focus lens 116 at the just-focus position securely and by stable movement in the case of moving it to the just-focus position, it is necessary, as the focus lens 116 gets closer to the just-focus position, to reduce the travel distance and slow the movement of the focus lens 116 accordingly so that the travel distance becomes zero and the movement speed of the focus lens 116 thereby becomes zero when reaching the just-focus position.

Thus, the CPU 154 acquires the difference ΔAFV(=AFV_A−AFV_B) between the ch A and ch B focus evaluation values, and sets as the travel distance the value ΔAFV×AFG acquired by multiplying the difference ΔAFV(=AFV_A−AFV_B) by a predetermined AF gain AFG. Thus, in the case where the focus lens 116 reaches the just-focus position, that is, in the case where the difference ΔAFV between the focus evaluation values becomes zero (AFV_A=AFV_B), the travel distance ΔAFV×AFG becomes zero so that the focus lens 116 stops at the just-focus position. As can be seen in FIG. 12, when the focus lens 116 gets closer to the just-focus position from around the just-focus position, the difference ΔAFV between the focus evaluation values is reduced and the travel distance ΔAFV×AFG gradually gets closer to zero so that the movement speed of the focus lens 116 is gradually reduced.

It is also possible to set the travel distance as follows instead of setting as the travel distance the value ΔAFV×AFG acquired by multiplying the difference ΔAFV between the ch A and ch B focus evaluation values by the predetermined AF gain AFG. To be more specific, the CPU 154 first acquires a ratio ΔAFV=AFV_A/AFV_B between the ch A focus evaluation value AFV_A and the ch B focus evaluation value AFV_B. In the case of AFV_A>AFV_B (ΔAFV>1), that is, in the case of the front focus (refer to FIG. 12), it sets the travel distance as (ΔAFV−1)×AFG. AFG indicates the value of the predetermined AF gain. In the case of AFV_A<AFV_B (ΔAFV<1), that is, in the case of the rear focus (or just focus), it sets the travel distance as −[1/(ΔAFV−1)]×AFG.

Thus, in the case where the focus lens 116 reaches the just-focus position, the travel distance becomes zero because of ΔAFV=1 so that the focus lens 116 stops at the just focus position. When the focus lens 116 gets closer to the just-focus position from around the just-focus position, (ΔAFV−1) or [1/(ΔAFV−1)] is reduced and the travel distance gradually gets closer to zero so that the movement speed of the focus lens 116 is gradually reduced.

The control for setting the focus at the just-focus position is not limited to the above-mentioned method but another method may also be used.

Next, a description will be given as to the control system related to aperture control of the lens apparatus 110 and electronic shutter control of the focus state determination image pickup elements 132A and 132B. As shown in FIG. 8, the taking lens of the lens apparatus 110 has the aperture 120 on the optical axis 0 and the AF-side aperture 127 on the optical axis O′ (focus state determination optical path) placed therein. The aperture 120 has the same object as the aperture of a general taking lens, and its object is mainly to adjust the amount of the object light incident on the video image pickup element of the camera body 112 to an appropriate amount of light.

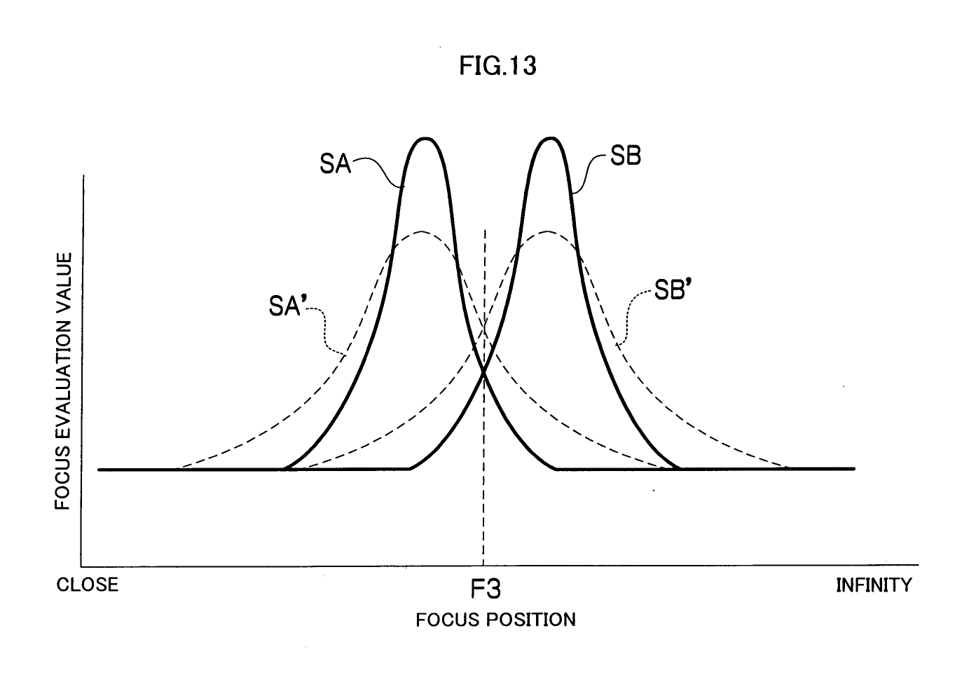

The object of the AF-side aperture 127 is mainly to correct the focal depth of the object light incident on the focus state determination image pickup elements 132A and 132B (hereafter, referred to as AF object light). For instance, in the case of shooting the object including a lot of high-frequency components, a distribution form of the focus evaluation values obtained from the focus state determination image pickup elements 132A and 132B becomes a hill-like curve having a precipitous inclination around the peak point as SA and SB in FIG. 13. Under these circumstances, if the focus movement speed is controlled based on the difference between the ch A and ch B focus evaluation values as described above, it becomes difficult to stop the focus at the just-focus point F3 because the focus movement speed is also fast in the proximity of the just-focus point F3. For this reason, there is a possibility of causing unstable focus movement such as the overshoot and hunting.

However, the focus evaluation value characteristic changes according to the focal depth of the AF object light, and it is possible to render the focus evaluation value characteristic around the peak point moderate by deepening the focal depth. For that reason, the AF-side aperture 127 is placed on the focus state determination optical path, and the focal depth of the AF object light is corrected by the AF-side aperture 127 so that the focus evaluation value characteristic around the peak point becomes moderate even for the object including a lot of high-frequency components, such as SA′ and SB′ indicated by the broken lines in FIG. 13 to avoid the above-mentioned problems.

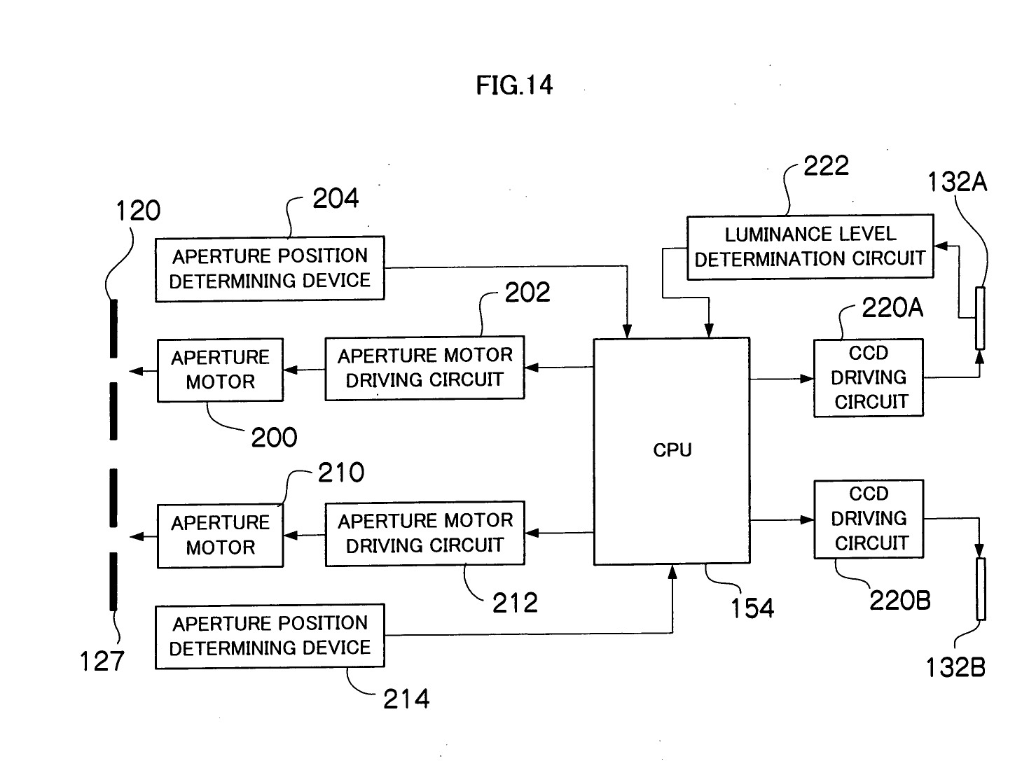

As shown in FIG. 14, the aperture 120 and the AF-side aperture 127 are coupled to aperture motors 200 and 210 respectively. If the aperture motors 200 and 210 are driven by aperture driving circuits 202 and 212, the opening amount (aperture value) of each of the aperture 120 and AF-side aperture 127 changes accordingly. The CPU 154 obtains aperture position signals indicating the values according to the current aperture values of each of the aperture 120 and AF-side aperture 127 from aperture position determining devices 204 and 214, and outputs the control signals to the aperture driving circuits 202 and 212 while doing so so that those signal values become the values indicating the objective aperture positions so as to drive the aperture motors 200 and 210. Thus, the aperture values of the aperture 120 and AF-side aperture 127 change, and each of them is set at the objective aperture value intended by the CPU 154.

An adequate aperture value of the aperture 120 is determined, for instance, by the processing circuit of the camera body 112 based on the picture signal obtained by the video image pickup element of the camera body 112 in such a way as to render the luminance level of the picture signal appropriate. The control signal indicating the aperture value is given to the CPU 154 from the camera body 112, and the aperture 120 is set at the aperture value by the above-mentioned control.

As opposed to this, the adequate aperture value of the AF-side aperture 127 is determined in such a way as to render the focal depth of the AF object light (the focus evaluation value characteristic around the peak) adequate as described above. However, the focal depth changes not only according to the aperture value of the AF-side aperture 127 but also according to the aperture value of the aperture 120. Therefore, the aperture value of the AF-side aperture 127 is set in consideration of the aperture value of the aperture 120 so that the aperture values implement appropriate focal depth after considering both the aperture 120 and AF-side aperture 127 as the entire optical system leading to the focus state determination image pickup elements 132A and 132B.

Here, according to this embodiment, the aperture value of the aperture 120 is not changed for the purpose of adjusting the focal depth of the AF object light. For this reason, it is possible, just in the case where the focal depth with the aperture 120 only is shallower than the appropriate focal depth, to adequately adjust the focal depth of the AF object light with the aperture value of the AF-side aperture 127. In this case, if the aperture value of the AF-side aperture 127 is adjusted to render the focal depth appropriate, the focal depth depends mostly on the aperture value of the AF-side aperture 127 and can hardly be influenced by the aperture value of the aperture 120. Even if it is influenced by the aperture value of the aperture 120, the value of the focal depth to be considered appropriate may vary to an extent. Therefore, it is possible to render the focal depth appropriate by setting the aperture value of the AF-side aperture 127 at a predetermined value without changing the aperture value of the AF-side aperture 127 according to the aperture value of the aperture 120.

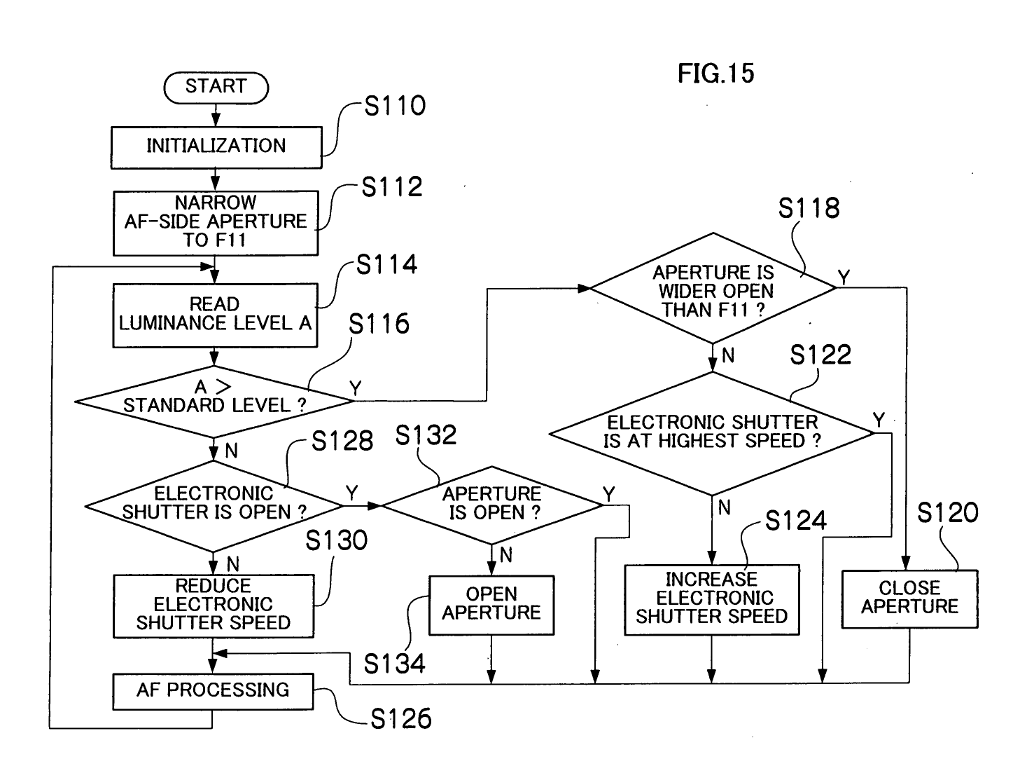

Thus, as to aperture control in the flowchart in FIG. 15 described later, the AF-side aperture 127 is set in principle at the predetermined aperture value (f-number 11 for instance) for rendering the focal depth appropriate.

In the case where the focal depth with the aperture 120 only is deeper than the appropriate focal depth, it is not possible to render the focal depth appropriate by adjusting the AF-side aperture 127. In this case, if the AF-side aperture 127 is set at the aperture value for rendering the focal depth appropriate as previously mentioned, the problem of further deepening the focal depth with the AF-side aperture 127 will not arise because the focal depth is hardly influenced by the aperture value of the AF-side aperture 127.

In the case where the aperture value of the AF-side aperture 127 is set to have the appropriate focal depth, there is a possibility that the luminance level of the images (picture signals) obtained from the focus state determination image pickup elements 132A and 132B is not appropriate so that the level of the focus evaluation values may become inappropriate. For that reason, the luminance level is adjusted mainly by an electronic shutter function for the focus state determination image pickup elements 132A and 132B. As already known, the electronic shutter function is an exposure control function for varying charge accumulation time (electronic shutter opening time) in light receiving portions of the focus state determination image pickup elements 132A and 132B. The electronic shutter opening time, that is, electronic shutter speed is controlled by CCD driving circuits 220A and 220B shown in FIG. 14 based on the command signal from the CPU 154. The luminance level of the picture signals obtained from the focus state determination image pickup elements 132A and 132B is determined by a luminance level determination circuit 222 having obtained the picture signals from the image pickup elements 132A for instance, and is given to the CPU 154. The luminance level can have an evaluation value, for instance, which is a summation of signal values of the picture signals corresponding to the pixels in the focus area.

The CPU 154 outputs the command signal to the CCD driving circuits 220A and 220B so that the luminance level determined as described above becomes an appropriate value (standard level), and thereby changes electronic shutter speed. However, in the case where the object is so dark that the luminance level does not reach the standard level even at the lowest electronic shutter speed (longest electronic shutter opening time), it changes the aperture value (increases the opening amount) of the AF-side aperture 127 and controls the luminance level to become the appropriate value.

Next, a concrete procedure for controlling the AF-side aperture 127 and the electronic shutter of the CPU 154 will be described by using the flowchart in FIG. 15. First, the CPU 154 performs the required initialization (step 110), and then narrows the AF-side aperture 127 to the aperture value (f-number) F11 (step S112). The aperture value F11 is the value determined in advance as the aperture value for rendering the focal depth of the AF object light appropriate. Next, the CPU 154 reads a luminance level A of the images (picture signals) picked up by the focus state determination image pickup elements 132A and 132B from the luminance level determination circuit 222 (step S114). It determines whether or not the luminance level A is higher than the standard level (step S116). If determined as YES, it subsequently determines whether or not the AF-side aperture 127 is wider open than the aperture value F11 (whether or not the aperture value is smaller than F11) (step S118). There are the cases where the AF-side aperture 127 is wider open than the aperture value F11 due to the step S132 described later. If determined as YES here, it closes the AF-side aperture 127 by a predetermined amount (step S120). The aperture value of the AF-side aperture 127 is not rendered narrower than F11 by this process.

If determined as NO at the step S118, it determines whether or not the electronic shutter speed of the focus state determination image pickup elements 132A and 132B is the highest speed (electronic shutter opening time is the shortest) (step S122). If determined as NO, it increases the electronic shutter speed by a fixed value (shortens the electronic shutter opening time by a fixed amount) (step S124). If determined as YES at the step S118, it performs nothing. As there can hardly be any case where the AF object light is bright enough to be determined as YES at the step S118, there is no specific problem even if no particular measure is taken.

If the process of the above step S120 or S124 is finished or if determined as YES at the step S118, the CPU 154 subsequently controls the focus of the taking lens based on the ch A and ch B focus evaluation values obtained from the focus state determination image pickup elements 132A and 132B as described above by the AF processing for focusing the taking lens (step S126). It repeats the process from the step S114.

If determined as NO at the step S116, it subsequently determines whether or not the electronic shutter speed is the lowest speed (open) (step S128). In the case where the luminance level A matches with the standard level, it is possible to perform the AF processing (step S126) without controlling the AF-side aperture 127 and the electronic shutter. In the case where the value of the standard level is in a certain range and the luminance level A is in that range, it is also possible to perform the AF processing (step S126) without controlling the AF-side aperture 127 and the electronic shutter. If determined as NO at the step S128, it reduces the electronic shutter speed by a fixed value (lengthens the electronic shutter opening time by a fixed amount) (step S130). To be more specific, in the case where the luminance level is lower than the standard level, it enhances the luminance level as much as possible by adjusting the electronic shutter speed.

If determined as YES at the step S128, it subsequently determines whether or not the AF-side aperture 127 is open (step S130). If determined as NO here, it opens the AF-side aperture 127 by a fixed amount (step S132). If determined as YES, it performs nothing.

If the process of the above step S130 or S134 is finished or if determined as YES at the step S130, it performs the above-mentioned AF processing at the step S126. It repeats the process from the step S14.

As for the process shown in the flowchart in FIG. 15, the process at the step S112 and S118 is performed considering that, irrespective of the aperture value of the aperture 120, the focal depth of the AF object light is appropriate in the case where the aperture value of the AF-side aperture 127 is the predetermined value (F11). It is also feasible, however, to perform the process at the step S112 and S118 considering that the focal depth is appropriate when the aperture value of the entire optical system is the predetermined value (F11 for instance) taking both the aperture values of the aperture 120 and the AF-side aperture 127 into consideration.

Next, a description will be given as to other embodiments of the concrete procedure relating to the control of the AF-side aperture 127 and the electronic shutter of the CPU 154. In the process shown in FIG. 15, the description was given as to the case where the aperture value for rendering the focal depth (focus evaluation value characteristic) appropriate is determined in advance. It is also possible, however, to control the AF-side aperture 127 and change the focal depth while determining whether or not the focus evaluation value characteristic is appropriate based on the focus evaluation value actually obtained so as to render the focus evaluation value characteristic appropriate.

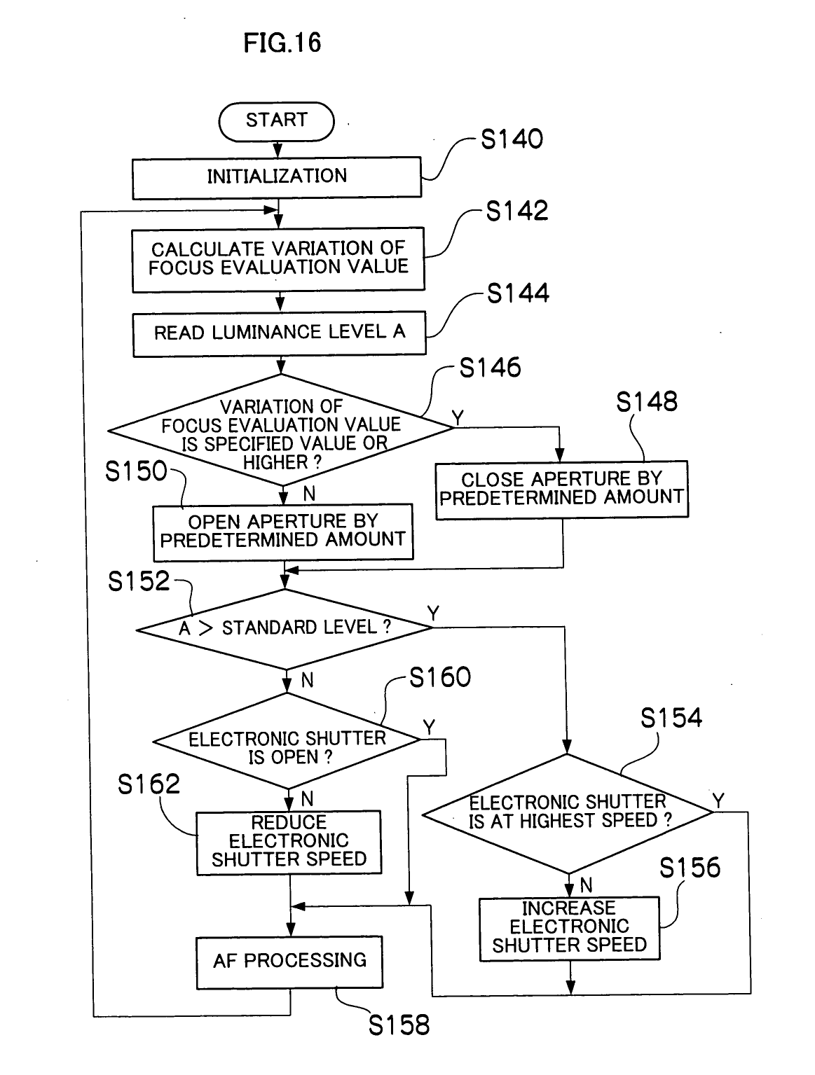

FIG. 16 is a flowchart showing the procedure of the CPU 154 in this case. First, the CPU 154 performs the required initialization (step S140), and then calculates a variation of the focus evaluation value from two ch A or ch B focus evaluation values obtained from the focus evaluation value generating portion 158 (step S142). It is also possible to acquire the variations of both the ch A and ch B focus evaluation values and take up a larger one. The CPU 154 subsequently reads the luminance level A of the images (picture signals) picked up by the focus state determination image pickup elements 132A and 132B from the luminance level determination circuit 222 (step S144).

Next, the CPU 154 determines whether or not the variation of the focus evaluation value calculated at the step 142 is a specified value or higher (step S146). If determined as YES, it closes the AF-side aperture 127 by a predetermined amount and deepens the focal depth (step S148). If determined as NO, it opens the AF-side aperture 127 by a predetermined amount and renders the focal depth shallower (step S150).

If the process of the step S148 or S150 is finished, the CPU 154 then determines whether or not the luminance level A obtained at the step S144 is higher than the standard level (step S152). If determined as YES, it determines whether or not the electronic shutter speed of the focus state determination image pickup elements 132A and 132B is the highest speed (electronic shutter opening time is the shortest) (step S154). If determined as NO, it increases the electronic shutter speed by the fixed value (shortens the electronic shutter opening time by a fixed amount) (step S156). If determined as YES at the step S154, it performs nothing. The CPU 154 controls the focus of the taking lens based on the ch A and ch B focus evaluation values obtained from the image pickup elements 132A and 132B as described above by the AF processing for focusing the taking lens (step S158). Subsequently, it repeats the process from the step S142.

If determined as NO at the step S152, it determines whether or not the electronic shutter speed is the lowest speed (open) (step S160). If determined as NO, it reduces the electronic shutter speed by the fixed value (lengthens the electronic shutter opening time by a fixed amount) (step S162). If determined as YES, it performs nothing. The CPU 154 performs the above-mentioned AF processing at the step S158. Subsequently, it repeats the process from the step S142.

As mentioned above, the above embodiment described the case of obtaining the two focus evaluation values from the focus state determination image pickup elements 132A and 132B so as to perform the AF control. However, the present invention is not limited thereto but is also applicable to the cases where the AF control is performed based on three or more focus evaluation values obtained from three or more image pickup elements placed at position of different optical lengths.

The above embodiment was described by taking the case of applying the present invention to the TV camera system as an example. However, the present invention is not limited thereto but is also applicable to a video camera and a still camera for capturing a static image.

Next, another embodiment will be described.

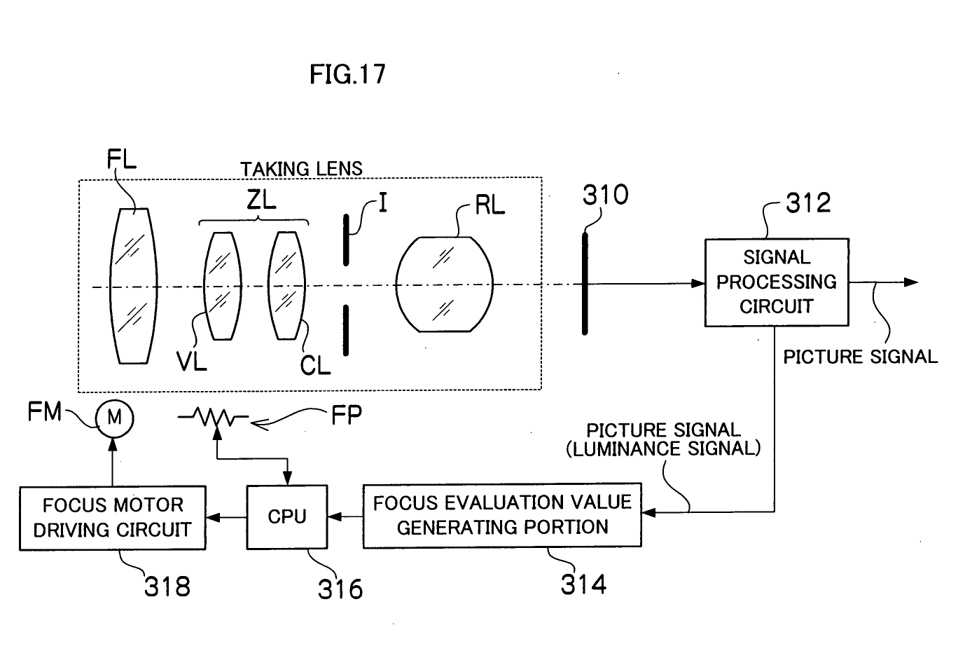

FIG. 17 is a block diagram showing an overall configuration of the auto focus system to which an embodiment of the present invention is applied. The auto focus system shown therein is generally applied to a TV camera. The taking lens (shooting optical system) has a focus lens (group) FL, a zoom lens (group) ZL comprised of a variator lens (group) VL and a compensator lens (group) CL, an iris I, a relay lens (group) RL and so on placed therein.

The object image formed by the above taking lens is photoelectrically transferred by an image pickup element (CCD) 310 of the TV camera body, and has required signal processing performed thereto by a predetermined signal processing circuit 312. Thus, the picture signals of a predetermined standard (NTSC method for instance) are outputted to the outside for graphic display from the signal processing circuit 312.

The signal processing circuit 312 also outputs the picture signals for the auto focus (AF) control, and the picture signals for the AF control are inputted to a focus evaluation value generating portion 314. The picture signals for the AF control are the luminance signals for instance, and voltage signals corresponding to the luminance values of the pixels constituting the screen are transmitted from the upper stage to the lower stage of the screen along the horizontal scanning lines. There are the thinkable cases where the focus evaluation value generating portion 314 and a CPU 316 described later are built into the camera body or built into a drive unit for motor-driving the moving portions (focus lens FL and so on) of the taking lens. However, they may be placed in any portion of the apparatuses constituting the system.

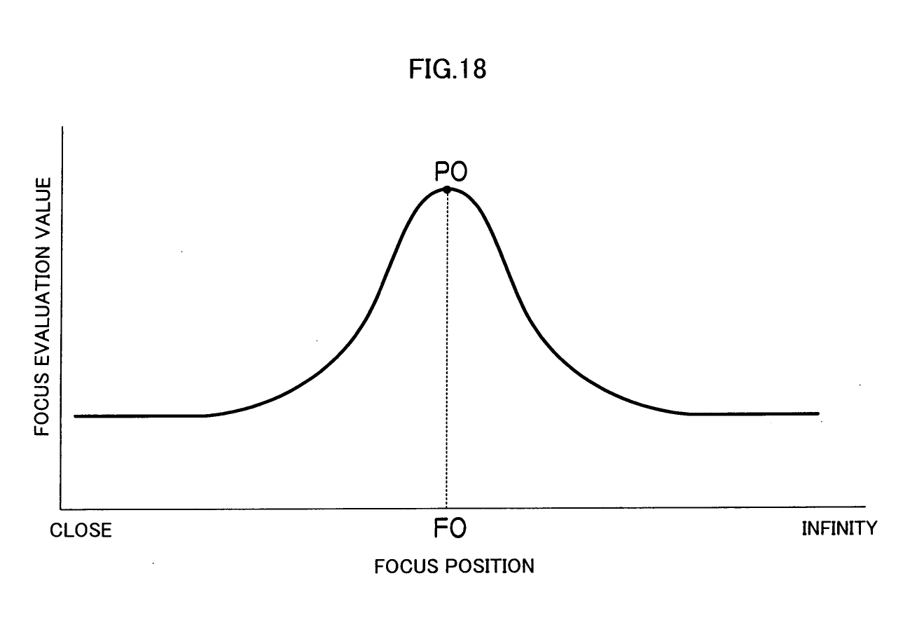

The focus evaluation value generating portion 314 of which detailed configuration will be described later generates the focus evaluation values indicating the contrast level (degree of sharpness) of captured images based on the picture signals given from the signal processing circuit 312. FIG. 18 is a diagram illustrating sizes of the focus evaluation values obtained by changing the position of the focus lens FL (focus position) on shooting a static object. As shown in FIG. 18, the focus evaluation values generally show a hill-like curve, and a focus position F0 on obtaining the focus evaluation value of a peak point P0 thereof is the best focus state.

The CPU 316 obtains the focus evaluation values generated by the focus evaluation value generating portion 314, and controls the auto focus based on the obtained focus evaluation values. The focus of the taking lens is changed by motor-driving the focus lens FL with the focus motor FM in the optical axis direction, and the focus motor FM is driven according to the control signal given to a focus motor driving circuit 318 from the CPU 316. The CPU 316 is given the position signal indicating the current position of the focus lens FL by a potentiometer FP. The CPU 316 controls driving of the focus motor FM while referring to the position signal so as to move the focus lens FL to a desired position.

In the auto focus control, the CPU 316 has the operation called wobbling for moving the focus of the taking lens back and forth performed, and determines the moving direction of the focus lens FL in which the focus evaluation value increases due to the focus evaluation value obtained from the focus evaluation value generating portion 314 in the meantime. The wobbling may either move the focus lens FL back and forth or move the wobbling-specific lens if there is one. Once the direction in which the focus evaluation value increases is determined, it subsequently moves the focus lens FL in that direction. If it is determined that the focus evaluation value decreased while moving the focus lens FL, it recognizes the peak point of the focus evaluation value and stops the focus lens FL at that position. The focus of the taking lens is thereby set in the best focus state.

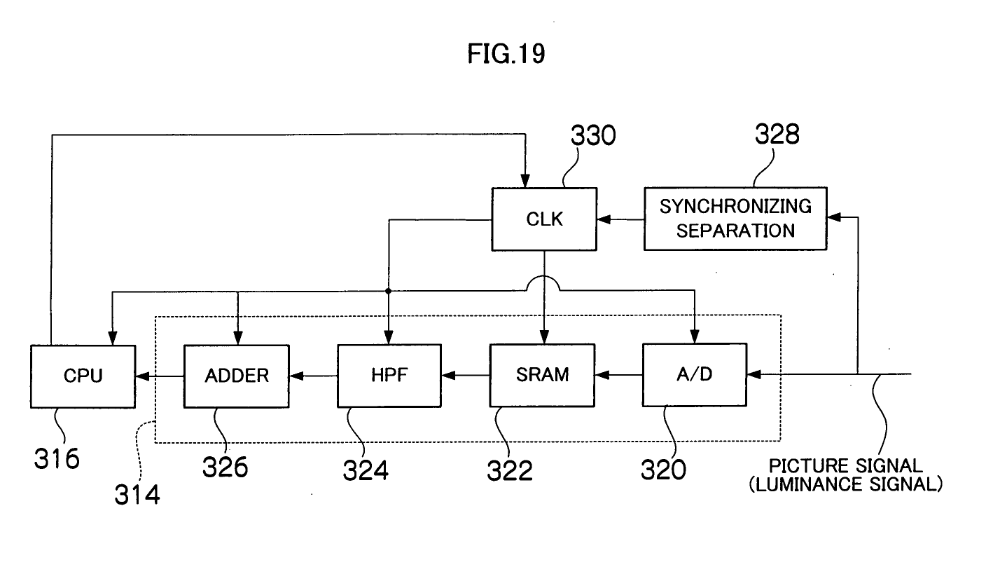

Next, FIG. 19 shows the configuration of the focus evaluation value generating portion 314 and its peripheral circuits. The focus evaluation value generating portion 314 is mainly comprised of an A/D converter 320, an SRAM 322, a high-pass filter (HPF) 324 and an adder 326. As shown in FIG. 17, the picture signal (luminance signal) outputted from the signal processing circuit 312 of the camera body is inputted to the focus evaluation value generating portion 314, and is first converted into the digital signal (referred to as pixel data) per pixel by the A/D converter 320. Then, of the pixel data sequentially outputted from the A/D converter 320, the pixel data within a predetermined period is temporarily stored in the SRAM 322. For instance, the SRAM 322 has only the pixel data in a predetermined range (focus area) on the screen as a subject of the auto focus stored therein. As for storage capacity of the SRAM 322, it is the capacity capable of storing the pixel data in the focus area of one screen, for instance. A storage circuit other than the SRAM may be used for the SRAM 322, and its storage capacity may also be different from the above-mentioned case.

The pixel data once stored in the SRAM 322 is sequentially read to the high-pass filter (HPF) 324 comprised of the digital filter. The pixel data read to the HPF 324 is converted into the pixel data in the case where, of the frequency components of the picture signals in the focus area, only the high-frequency components are extracted by interrupting the frequency components lower than a predetermined cut-off frequency fc.

The pixel data obtained by the HPF 324 is sequentially outputted to the adder 326, and is added up per focus area range of one screen by the adder 326. Thus, data on the focus evaluation values is generated, and the data is read by the CPU 316.

As for the peripheral circuits of the focus evaluation value generating portion 314, a synchronizing separation circuit 328 and a clock generation circuit 330 for generating clock signals and so on for synchronizing processing operations of the circuits are placed. The picture signal outputted from the signal processing circuit 312 of the camera body is inputted to the focus evaluation value generating portion 314, and is also branched to the synchronizing separation circuit 328. A horizontal synchronizing signal is separated from the picture signal by the synchronizing separation circuit 328 so that the horizontal synchronizing signal is given to the clock generation circuit 330.

The clock generation circuit 330 provides the clock signals of a fixed frequency to the above A/D converter 320, HPF 324, adder 326 and CPU 316 in timing for the horizontal synchronizing signal provided by the synchronizing separation circuit 328 so as to synchronize circuit operations thereof.

As opposed to this, it provides to the SRAM 322 a write clock for ordering writing of the data in timing for output of each piece of the pixel data only in the period when the pixel data in the focus area is outputted from the A/D converter 320. Thus, only the pixel data in the focus area is stored in the SRAM 322. It also provides to the SRAM 322 a read clock for ordering reading of the data stored in the SRAM 322.

Here, the frequency of the read clock provided to the SRAM 322 from the clock generation circuit 330 is not fixed, and is changed by a command from the CPU 316. For instance, in the case where the frequencies of the write clock and read clock are the same, the pixel data is read from the SRAM 322 at the same speed as writing the pixel data to SRAM 322. In this case, a transmission speed to the HPF 324 of the picture signals outputted from the signal processing circuit 312 is not changed in the SRAM 322. To be more specific, the speed at which the voltage signal corresponding to each pixel is sequentially outputted as the picture signal from the signal processing circuit 312 matches with the speed at which each piece of the pixel data is sequentially inputted to the HPF 324. Therefore, of the frequency components of the picture signals outputted from the signal processing circuit 312, the upper limit of the frequency components interrupted by the HPF 324 (lower limit of the frequency components passing through the HPF 324), that is, the cut-off frequency is the cut-off frequency fc specified as the frequency characteristic of the HPF 324.

In the case where the frequencies of the write clock and read clock are different because of a change in the frequency of the read clock, the pixel data is read from the SRAM 322 at a speed different from the speed at which the pixel data is written to the SRAM 322. In this case, the transmission speed to the HPF 324 of the picture signals outputted from the signal processing circuit 312 is changed in the SRAM 322. To be more specific, the speed at which the voltage signal corresponding to each pixel is sequentially outputted as the picture signal from the signal processing circuit 312 is different from the speed at which each piece of the pixel data is sequentially inputted to the HPF 324. Therefore, when the frequency components of the picture signals outputted from the signal processing circuit 312 are inputted to the HPF 324, they are converted into different frequency components. For this reason, of the frequency components of the picture signals outputted from the signal processing circuit 312, the upper limit of the frequency components interrupted by the HPF 324 changes from the cut-off frequency fc.

For instance, it is assumed that the frequency of the read clock is n times higher than that of the write clock, and reading speed from the SRAM 322 is n times higher than writing speed thereto. It then means that the transmission speed of the picture signals is converted to n times by the SRAM 322. When the frequency components of the picture signals outputted from the signal processing circuit 312 are inputted to the HPF 324, they are converted into the frequencies of n times. As opposed to this, the cut-off frequency fc of the HPF 324 is fixed, so that it is equivalent to changing the cut-off frequency of the HPF 324 for the picture signals outputted from the signal processing circuit 312 to fc/n.

To show concrete examples of numerical values, the specified cut-off frequency fc of the HPF 324 is 4 MHz for instance, and the frequency of the read clock is 1, 2 or 4 times higher than that of the write clock, that is, the value of the above n is changed to 1, 2 or 4. In this case, the cut-off frequency of the HPF 324 is equivalently changed to one of 4 MHz, 2 MHz or 1 MHz.

It is preferable to render the specified cut-off frequency fc of the HPF 324 as high as possible for the sake of reducing a degree (tap number) and thereby reducing the circuit size of the HPF 324. It is not necessary to render one of the equivalently changed cut-off frequencies of the HPF 324 as a specified cut-off frequency fc of the HPF 324.

The frequency of the read clock is changed according to the command from the CPU 316. However, the change condition is not limited to the case of a specific condition. For instance, there are the thinkable cases such as changing the frequency of the read clock according to a user instruction, automatically changing the frequency of the read clock according to the condition of the shooting object, shooting conditions and so on. In general, it is thinkable, as the change conditions, to lower the frequency of the read clock and raise the equivalent cut-off frequency of the HPF 324 if highly accurate focusing is required, and to raise the frequency of the read clock and lower the equivalent cut-off frequency of the HPF 324 if priority is given to increasing the speed of focusing rather than accuracy.

Subsequently, a variable range of the frequency of the read clock will be described. When the write clock is at the predetermined frequency, the time required for writing (write time) all the pixel data in the focus area in one horizontal scanning period (1H) to the SRAM 322 is 1H×(1/m). In this case, it is possible to extend the time required for reading the pixel data from the SRAM 322 up to at least the time of 1H×{(m−1)/m} as remaining time of one horizontal scanning period 1H, that is, (m−1) times of the write time. As for the frequency of the clock, it is possible to lower the frequency of the read clock to 1/(m−1) times against the frequency of the write clock.

If the SRAM 322 can simultaneously operate on the write clock and read clock of different frequencies, it is possible to extend the read time to 1H which is m times of the write time 1H×(1/m). The focus information, in the case of further extending the read time (read speed), to cope with it by placing the processing subject on a predetermined number of horizontal scanning lines.

There is basically no time limit to the direction for accelerating the frequency of the read clock due to picture signal specifications and so on, and it depends on processing ability of the HPF 324.

Thus, it is possible, without changing the frequency characteristic (cut-off frequency) of the HPF 324 and using a plurality of HPFs of different cut-off frequencies, to reduce the cost and miniaturize the circuit size by changing the transmission speed of the picture signals and thereby equivalently changing the cut-off frequency of one HPF 324. It is also possible, by miniaturizing the circuit size, to allocate free space for the sake of improvement of performance such as enhancing the frequency characteristics including the cut-off frequency of the HPF. It is further possible to slowly read and process the high frequency signals stored in the SRAM 322 on certain conditions such as processing in a part of the screen so as to allow application in high-speed processing in the circuit not supporting the high-speed processing.

The above embodiment described the case of applying the present invention to the auto focus system. However, it may also be applied to other apparatuses and systems.

The above embodiment also described the case of rendering the cut-off frequency of one HPF 324 changeable. However, the present invention is applicable to the filters other than the high-pass filter and having the frequency characteristics equivalent to the cut-off frequency of a low-pass filter, a band pass filter and so on.

The present invention is not limited to the cases of being applied to the auto focus system.

As described above, according to the auto focus system related to the present invention, the focus information necessary for the auto focus is sent to the lens apparatus from the camera body, and the auto focus is controlled on the lens apparatus side based on the focus information. Therefore, it is possible to control the focus on the conditions adequate to the optical specifications of the lens apparatus and so on.

Moreover, the aperture is placed on the focus state determination optical path so that the focal depth of the object light led to the focus state determination optical path can be adjusted. For this reason, it is possible to change the characteristic around the peak of the focus evaluation value. Therefore, it is possible to adjust the object including a lot of high-frequency components so that the characteristic around the peak of the focus evaluation value will not be precipitous so as to allow focusing securely with natural and stable movement and without problems such as the overshooting and hunting.

Furthermore, the same effect as changing the cut-off frequency of the filter is obtained by changing the speed of transmitting to the filter the signal to be inputted to the filter without changing the frequency characteristic of the filter. Thus, it is not necessary to change the frequency characteristic of the filter or to use a plurality of filters of different frequency characteristics (cut-off frequencies) even in the case of changing the frequency components to be interrupted (frequency components to be transmitted) by the filter against the frequency components of the subject signal. Therefore, it allows the cost reduction and miniaturization of the circuit size of the filter and its peripheral circuits.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An auto focus system, comprising:
a camera body; and
a lens apparatus which is detachably mounted on the camera body,
wherein the camera body comprises:
a focus information obtaining device which obtains focus information based on a picture signal obtained by picking up an image with an image pickup device; and
a sending device which sends the focus information obtained by the focus information obtaining device to a focus control device of the lens apparatus,
wherein the lens apparatus comprises:
an optical system for focusing object light; and
the focus control device which comprises:
a receiving device which receives the focus information sent by the sending device of the camera body; and
an auto focus control device which electrically controls focus of the optical system based on the focus information received by the receiving device so as to automatically perform focusing.

2. The auto focus system as defined in claim 1, wherein the focus control device sends to the camera body a focus range on a screen specified as a range to be focused on by a focus range specification device attached to the lens apparatus.

3. The auto focus system as defined in claim 1, wherein, in the camera body, light to be incident on a video image pickup element is divided into rays for focus state determination, and images of the rays for focus state determination are picked up on a plurality of imaging surfaces placed with optical length differences, and the focus information is obtained based on the picture signals obtained by picking up the images on the imaging surfaces.

4. The auto focus system as defined in claim 3, wherein the focus control device sends to the camera body a focus range on a screen specified as a range to be focused on by a focus range specification device attached to the lens apparatus.

5. The auto focus system as defined in claim 3, wherein the focus information is a focus evaluation value generated based on signals of necessary frequency components extracted from the picture signals obtained by picking up the images on the plurality of imaging surfaces.

6. The auto focus system as defined in claim 5, wherein the focus control device sends to the camera body a focus range on a screen specified as a range to be focused on by a focus range specification device attached to the lens apparatus.

7. The auto focus system as defined in claim 5, wherein the focus control device demands from the camera body the frequency components necessary for the focus information unique to the lens apparatus.

8. The auto focus system as defined in claim 7, wherein the focus control device sends to the camera body a focus range on a screen specified as a range to be focused on by a focus range specification device attached to the lens apparatus.

9. An auto focus system, comprising:
an object light branching device which branches an object light incident on a taking lens from an optical path for obtaining an object image to a focus state determination optical path;
a plurality of image pickup devices which pick up images of the object light led to the focus state determination optical path by the object light branching device at positions of different optical lengths;
a focus evaluation value generation device which generates a focus evaluation value indicating a degree of sharpness of the image picked up by each of the image pickup devices;
a focus control device which controls a focus of the taking lens based on the focus evaluation value generated by the focus evaluation value generation device in correspondence with each of the image pickup devices so as to adjust focus of the taking lens; and
an aperture which is placed on the focus state determination optical path so that focal depth of the object light led to the focus state determination optical path is adjusted by adjusting an opening amount of the aperture.

10. A filter cut-off frequency change circuit, comprising:
a filter which, of frequency components of an inputted signal, interrupts one of a frequency component over a predetermined cut-off frequency and a frequency component below the predetermined cut-off frequency; and
a transmission speed change circuit which changes a transmission speed of the inputted signal and outputting the signal to the filter,
wherein the transmission speed is changed in the transmission speed change circuit so as to change the frequency component interrupted by the filter against the frequency component of the signal inputted to the transmission speed change circuit.

11. The filter cut-off frequency change circuit as defined in claim 10, wherein the transmission speed change circuit comprises:
a storage circuit which temporarily stores the inputted signal; and
a read speed control circuit which changes a speed of reading from the storage circuit in order to output the signal stored in the storage circuit to the filter.

12. An auto focus system, comprising:
a high-pass filter which interrupts a frequency component below a predetermined cut-off frequency to extract a high-frequency component from a picture signal obtained by photoelectrically transferring an image formed by an optical system; and
a transmission speed change circuit which changes a transmission speed of inputted picture signal and outputs the picture signal to the high-pass filter,
wherein the transmission speed is changed in the transmission speed change circuit so as to change the frequency component interrupted by the high-pass filter against the frequency component of the picture signal inputted to the transmission speed change circuit,
wherein the auto focus system automatically performs focusing of the optical system based on the high-frequency component extracted by the high-pass filter.

13. The auto focus system as defined in claim 12, wherein the transmission speed change circuit comprises:
a storage circuit which temporarily stores the inputted picture signal; and
a read speed control circuit which changes a speed of reading from the storage circuit in order to output the picture signal stored in the storage circuit to the high-pass filter.
